(19) United States
(12) Patent Application Publication
(10) Pub. No.: US 2013/0005586 A1
(43) Pub. Date: Jan. 3, 2013

(54) METHOD OF DIAGNOSTIC OF OBESITY

(76) Inventor: Stanislav Ehrlich, Orsay (FR)

(21) Appl. No.: 13/582,375

(22) PCT Filed: Mar. 1, 2011
(86) PCT No.: PCT/EP2011/053041

§ 371 Date: Aug. 31, 2012

Related U.S. Application Data
(60) Provisional application No. 61/309,333, filed on Mar. 1, 2010.

(51) Int. Cl. C40B 20/00; C40B 40/06

(52) U.S. Cl. 506/2; 506/16

(57) ABSTRACT

A new method for diagnosing obesity is herein described, based on the determination of the absence of at least one gene from the human' gut microbiome.

The human intestinal microbiota constitutes a complex ecosystem now well recognized for its impact on human health and well being. It does contribute to maturation of the immune system and direct barrier against colonization by pathogens. Over the second half of the past century, infectious diseases have been dramatically reduced and major pathogens have been put under control. During the same period, a number of “immune” diseases have followed a constant increase in prevalence, especially in western societies. This has been the case for allergies, inflammatory bowel diseases, irritable bowel syndrome and possibly metabolic and degenerative disorders such as obesity, metabolic syndrome, diabetes and cancer. The sequence of the human genome has lead to the observation of genes associated with an increased risk for immune diseases but mutations in these genes will most often only explain a small fraction of the actual cases and genetic predisposition will require environmental triggers to actually cause a disease. Among environmental components, the intestinal microbiota has recently gained a marked recognition as a key player.

The analysis of the molecular composition of the intestinal microbiota in healthy humans indicates marked inter-individual variations which may seem paradoxical considering the high degree of conservation of major functions of the intestinal microbiota such as anaerobic digestion of alimentary fibres. Recent high throughput and culture independent molecular observations have lead to the description of a core within the human intestinal microbiota, in terms of species but also at the level of genes; i.e. a set of conserved entities that could be responsible for major conserved functionalities.

The current knowledge permits to define criteria qualifying the normal state of the human intestinal microbiota, i.e. normobiosis. This further allows identifying specific distortions from normobiosis, i.e. dysbiosis, in immune, metabolic or degenerative diseases. The exploration of dysbiosis may be viewed as a primary step providing key information for the design of strategies aiming at restoring or maintaining homeostasis and normobiosis. In addition, criteria qualifying dysbiosis in a strictly defined, well phenotyped, disease context will be valuable elements to design diagnosis models. Although so far restricted to microbiota composition and/or diversity, dysbiosis has been suspected for several diseases and in a few cases it has already been partially documented, e.g. in obesity. Indeed, nutrition plays a crucial role in directly modulating our microbiomes and health phenotypes. Poorly balanced diets can turn the gut microbiome from a partner for health to a “pathogen” in chronic diseases. Accumulating evidence supports the hypothesis that obesity and related metabolic diseases develop because of low-grade, systemic and chronic inflammation induced by diet-disrupted gut microbiota. There is thus still a need for a new, reliable method allowing a consistent diagnosis of obesity.

Most intestinal commensals cannot be cultured. Genomic strategies have been developped to overcome this limitation (Hamady and Knight, Genome Res, 19: 1141-1152, 2009). These strategies have allowed the definition of the microbiome as the collection of the genes comprised in the genomes of the microbiota (Turnbaugh et al., Nature, 449: 804-8010, 2007; Hamady and Knight, Genome Res., 19: 1141-1152, 2009). The existence of a small number of species shared by all individuals constituting the human intestinal microbiota phylogenetic core has been demonstrated (Tap et al., Environ Microbiol., 11(10): 2574-2584, 2009). Recently, a metagenomic analysis has led to the identification of an extensive catalogue of 3.3 million non-redundant microbial genes of the human gut, corresponding to 576.7 gigabases of sequence (Qin et al., Nature, 2010, doi:10.1038/nature08821).

The inventors have used a method based on the isolation and sequencing of DNA fragments from human faeces in different individuals. Since an extensive catalogue of microbial genes from the gut is now available (Qin et al., Nature, 2010, doi:10.1038/nature08821), the number of copies and the frequency of a specific sequence in a specific population (e.g. patients suffering from obesity) can be calculated. It is thus possible to identify any correlation between the presence or absence of a specific gene and the presence or absence of a specific pathology. In addition, the number of copies of a specific gene in an individual can be determined.

The inventors were able to identify genes which are significantly different between a group of obese patients, and a control group of lean, healthy people. These genes are listed in Table 1. The said genes are more numerous in lean individuals than in the patients. This observation is statistically significant, since the total number of microbial genes is not different in both populations. There is thus a loss of specific human's gut microbial genes in individuals suffering from obesity.

A first aspect of this invention is a method for diagnosing obesity, said method comprising a step of determining whether at least one gene is absent from an individual's gut microbiome. By “individual's gut microbiome”, it is herein understood all the genes constituting the microbiota of the said individual. The term “individual's gut microbiome” thus corresponds to all the genes of all the bacteria present in the said individual's gut.

A gene is absent from the microbiome when its number of copies in the microbiome is under a certain threshold value. According to the present invention, a “threshold value” is intended to mean a value that permits to discriminate samples in which the number of copies of the gene of interest corresponds to a number of copies in the individual's microbiome that is low or high. In particular, if a number of copies is inferior or equal to the threshold value, then the number of copies of this gene in the microbiome is considered low, whereas if the number of copies is superior to the threshold value, then the number of copies of this gene in the microbiome is considered high. A low copy number means that the gene is absent from the microbiome, whereas a high number of copies means that the gene is present in the microbiome. For each gene, and depending on the method used for measuring the number of copies of the gene, the optimal threshold value may vary. However, it may be easily determined by a skilled artisan based on the analysis of the microbiome of several individuals in which the number of copiesl (low or high) is known for this particular gene, and on the comparison thereof with the number of copies of a control gene.

The method of the invention thus allows the skilled person to diagnose a pathology solely on the basis of the presence or the absence of a gene from the individual's gut microbiome. There is a direct correlation between the number of copies of a specific gene and the number of bacterial cells carrying this gene. The method of the invention thus allows the skilled person to detect a dysbiosis, i.e. a microbial imbalance, by analysis of the microbiome. Not all the species in the gut have been identified, because most cannot be cultured, and identification is difficult. In addition, most species found in the gut of a given individual are rare, which makes them difficult to detect (Hamady and Knight, Genome Res., 19: 1141-1152, 2009). In this first aspect of the invention, no prior identification of the bacterial species the said gene belongs to is required. The method of diagnosis of the invention is thus not restricted to the determination of a change in the population of known gut's bacterial species, but encompasses also the bacteria which have not yet been characterized taxiconomically.

There are several ways to obtain samples of the said individual's gut microbial DNA (Sokol et al., Inflamm. Bowel Dis., 14(6): 858-867, 2008). For example, it is possible to prepare mucosal specimens, or biopsies, obtained by coloscopy. However, coloscopy is an invasive procedure which is ill-defined in terms of collection procedure from study to study. Likewise, it is possible to obtain biopies through surgery. However, even more than coloscopy, surgery is an invasive procedure, which effects on the microbial population are not known. Preferred is the faecal analysis, a procedure which has been reliably been used in the art (Bullock et al., Curr Issues Intest Microbiol.; 5(2): 59-64, 2004; Manichanh et al., Gut, 55: 205-211, 2006; Bakir et al., Int J Syst Evol Microbiol, 56(5): 931-935, 2006; Manichanh et al., Nucl. Acids Res., 36(16): 5180-5188, 2008; Sokol et al., Inflamm. Bowel Dis., 14(6): 858-867, 2008). An example of this procedure is described in the Methods section of the Experimental Examples. Faeces contain about 10¹¹ bacterial cells per gram (wet weight) and bacterial cells comprise about 50% of faecal mass. The microbiota of the faeces represent primarily the microbiology of the distal large bowel. It is thus possible to isolate and analyse large quantities of microbial DNA from the faeces of an individual. By “microbial DNA”, it is herein understood the DNA from any of the resident bacterial communities of the human gut. The term “microbial DNA” encompasses both coding and non-coding sequences; it is in particular not restricted to complete genes, but also comprises fragments of coding sequences. Faecal analysis is thus a non-invasive procedure, which yields consistent and directly-comparable results from patient to patient.

Therefore, in a preferred embodiment, the method of the invention comprises a step of obtaining microbial DNA from faeces of the said individual. In a further preferred embodiment, the faeces from said individual are collected, DNA is extracted, and the presence or absence from an individual's gut microbiome of at least one gene is determined. The presence or absence of a gene may be determined by all the methods known to the skilled person. For instance, the whole microbiome of the said individual may be sequenced, and the presence or absence of the said gene searched with the help of bioinformatics methods. One instance of such a strategy is described in the Methods section of the Experimental Examples. Alternatively, the gene of interest may be looked for in the microbiome by hybridization with a specific probe, e.g. by Southern hybridization. It will be immediately apparent to the person of skills in the art that, in this particular embodiment, although Southern hybridization is perfectly suitable, it is nevertheless more convenient and sensitive to use microarrays. In yet another embodiment, the presence of the gene of interest may be detected by amplification, in particular by quantitative PCR (qPCR). These technologies (Southern, microarrays, qPCR, etc) are now used routinely by those skilled in the art and thus do not need to be detailed here.

In another preferred embodiment, the gene which absence or presence from the individual's gut microbiome is determined is selected from the group of genes listed in Tables 1. The skilled person will have no difficulty in realizing that the more genes are tested, the higher the degree of confidence of the result. According to another further preferred embodiment, the method of the invention comprises determining the presence or absence of at least 50% of the genes listed in Table 1, more preferably, at least 75% of the genes of Table 1, even more preferably, at least 90% of the genes of Table 1.

Even though a great number of the bacterial species found in the microbial flora have not been identified, it is known that most bacteria belong to the genera Bacteroides, Clostridium, Fusobacterium, Eubacterium, Ruminococcus, Peptococcus, Peptostreptococcus, and Bifidobacterium. Other genera such as Escherichia and Lactobacillus are present to a lesser extent. Some individual species belonging to these genera have been identified, and some of the genes of these species are known. The extensive metagenomic study which has led to the identification of 3.3 million non-redundant microbial genes has also permitted the assignment of most new sequences. A gene belonging to a given species is present in an individual at the same frequency as all the other genes of the said species. It is thus possible for each of the genes identified through the method of the invention to determine whether there is a correlation between the presence or absence of the said gene and the presence or absence of a set of genes known to belong to a specific bacterial species in various individuals. Such a correlation indicates that the unknown gene belongs to the said specific bacterial species. The inventors have thus shown that some bacterial species are associated with obesity whereas other bacterial species are associated with the lean phenotype. The obese phenotype can be predicted by a linear combination of the said species, i.e. the more bacterial species associated with the obese phenotype are present in an individual's gut, and the lesser species associated with the lean phenotype in the said individual's gut, the higher the probability that the said individual suffers from obesity. For example, the absence of Bacteronides pectinophilus, Eubacterium siraeum and Clostridium phyto fermentans and the presence of Anaerotruncus colihominis in the gut of a person indicates that this person suffers from obesity.

It will be clear for the person skilled in the art that the genes of the invention can be used as biomarkers, for example during the treatment of patients suffering from obesity. Therefore, in another embodiment, the invention includes a method for monitoring the efficacy of a treatment for obesity. When a treatment is efficacious against obesity, the dysbiosis initially observed gradually disappears. Whereas some specific genes are absent from the individual's guts when that said individual is obese (e.g. the genes of Table 1), these genes reappear during the treatment. In this embodiment, the method of the invention thus comprises the steps of first determining whether at least one gene is absent from the said patient's microbiome, administering the treatment, determining if the said at least one gene is present in the patient's microbiome. In a preferred embodiment, the method of the invention comprises the steps of obtaining microbial DNA from faeces of the said individual, before and after the treatment. In a further preferred embodiment, the faeces from said individual are collected before and after the treatment, DNA is extracted, and the presence or absence from an individual's gut microbiome of at least one gene is determined.

In another preferred embodiment, the gene which absence or presence from the individual's gut microbiome is determined is selected from the group of genes listed in Tables 1. In a particular embodiment, the method of the invention comprises determining the presence or absence of at least 50% of the genes listed in Table 1, more preferably, at least 75% of the genes of Table 1, even more preferably, at least 90% of the genes of Table 1.

The present invention also includes a kit dedicated to the implementation of the methods of the invention, comprising all the genes which are absent in a patient suffering from obesity and which are present in a lean, healthy person. In particular, the present invention relates to a microarray dedicated to the implementation of the methods according to the invention, comprising probes binding to all the genes absent in a patient suffering from obesity and present in a lean person. In a preferred embodiment, said microarray is a nucleic acid microarray. According to the invention, a “nucleic microarray” consists of different nucleic acid probes that are attached to a substrate, which can be a microchip, a glass slide or a microsphere-sized bead. A microchip may be constituted of polymers, plastics, resins, polysaccharides, silica or silica-based materials, carbon, metals, inorganic glasses, or nitrocellulose. Probes can be nucleic acids such as cDNAs (“cDNA microarray”) or oligonucleotides (“oligonucleotide microarray”, the oligonucleotides being about 25 to about 60 base pairs or less in length). Alternatively to nucleic acid technology, quantitative PCR may be used and amplification primers specific for the genes to be tested are thus also very useful for performing the methods according to the invention. The present invention thus further relates to a kit for diagnosing obesity in a patient, comprising a dedicated microarray as described above or amplification primers specific for genes absent in a patient suffering from obesity and present in a healthy person. Whereas these kits may allow the skilled person to detect 10%, 25%, 50% or 75% of the said genes, they are most useful when they allow the detection of 90%, 95%, 97.5% or even 99% of the said genes. Thus a microarray according to the invention will comprise probes binding to at least 10%, 25%, 50% or 75%, and preferably 90%, 95%, 97.5%, and even more preferably at least 99% of the said genes. Likewise a kit for quantitative PCR will contain primers allowing the amplification of at least 10%, 25%, 50% or 75%, and preferably 90%, 95%, 97.5%, and even more preferably at least 99% of the said genes. In a preferred embodiment, the genes which are absent in an obese patient and are present in lean people are the genes listed in Table 1.

### FIGURE LEGENDS

FIG. 1: Overall analysis of the BMI genes: there are more BMI genes in healthy individuals. A) Plot of the number of genes per individual in function the BMI indicates that the genes are more numerous in lean than the obese individuals. B) Ranking by gene number and binning by groups of 20 illustrates that lean are at the top of the distribution—out of 67 lean 50 are in the first three bins.

FIG. 2: A) A linear combination of 4 species discriminates well the obesity phenotype for the part of the cohort that harbors them at the levels defined (at least 50% of the genes); lean and obese individuals are shown as blue and red dots, respectively; B) Groups of individuals having at least half of the genes of “good species” in excess to the “bad” or half of the genes of a “bad species” in excess to “good” (cutoffs>0.5 & <−0.5, respectively).

### METHODS

Human Faecal Sample Collection.

Danish individuals were from the Inter-99 cohort (Toft. et al., Prev. Med., 47: 378-383, 2008), varying in phenotypes according to BMI (body/mass index) and status towards obesity/diabetes. Patients and healthy controls were asked to provide a frozen stool sample. Fresh stool samples were obtained at home, and samples were immediatelyfrozen by storing them in their home freezer. Frozen samples were delivered to the hospital using insulating polystyrene foam containers, and then they were stored at −80° C. until analysis.

DNA Extraction.

A frozen aliquot (200 mg) of each faecal sample was suspended in 250 μl of guanidine thiocyanate, 0.1M Tris (pH 7.5) and 40 μl of 10% N-lauroyl sarcosine. Then, DNA extraction was conducted as previously described (Manichanh et al., Gut, 55: 205-211, 2006). The DNA concentration and its molecular size were estimated by nanodrop (Thermo Scientific) and agarose gel electrophoresis.

DNA Library Construction and Sequencing.

DNA library preparation followed the manufacturer's instruction (Illumina). We used the same workflow as described elsewhere to perform cluster generation, template hybridization, isothermal amplification, linearization, blocking and denaturization and hybridization of the sequencing primers. The base-calling pipeline (version IlluminaPipeline-0.3) was used to process the raw fluorescent images and call sequences. We constructed one library (clone insert size 200 bp) for each of the first 15 samples, and two libraries with different clone insert sizes (135 by and 400 bp) for each of the remaining 109 samples for validation of experimental reproducibility. To estimate the optimal return between the generation of novel sequence and sequencing depth, we aligned the Illumina GA reads from samples MH0006 and MH0012 onto 468,335 Sanger reads totalling to 311.7 Mb generated from the same two samples (156.9 and 154.7 Mb, respectively), using the Short Oligonucleotide Alignment Program (SOAP) (Li et al., Bioinformatics, 25: 1966-1967, 2009). and a match requirement of 95% sequence identity. With about 4 Gb of Illumina sequence, 94% and 89% of the Sanger reads (for MH0006 and MH0012, respectively) were covered. Further extensive sequencing, to 12.6 and 16.6 Gb for MH0006 and MH0012, respectively, brought only a moderate increase of coverage to about 95%. More than 90% of the Sanger reads were covered by the Illumina sequences to a very high and uniform level, indicating that there is little or no bias in the Illumina GA sequence. As expected, a large proportion of Illumina sequences (57% and 74% for M0006 and M0012, respectively) was novel and could not be mapped onto the Sanger reads. This fraction was similar at the 4 and 12-16 Gb sequencing levels, confirming that most of the novelty was captured already at 4 Gb.

We generated 35.4-97.6 million reads for the remaining 122 samples, with an average of 62.5 million reads. Sequencing read length of the first batch of 15 samples was 44 by and the second batch was 75 bp.

Public Data Used

The sequenced bacteria genomes (totally 806 genomes) deposited in GenBankwere downloaded from the NCBI database (http://www.ncbi.nlm.nih.gov/) on 10 Jan. 2009. The known human gut bacteria genome sequences were downloaded from HMP database (http://www.hmpdacc-resources.org/cgi-bin/hmp_catalog/main.cgi), GenBank (67 genomes), Washington University in St Louis (85 genomes, version April 2009, http://genome.wust1.edu/pub/organism/Microbes/Human_Gut_Microbiome/), and sequenced by the MetaHIT project (17 genomes, version September 2009, http://www.sanger.ac.uk/pathogens/metahit/). The other gut metagenome data used in this project include: (1) human gut metagenomic data sequenced from US individuals (Zhang et al., Proc. Natl Acad. Sci. USA, 106: 2365-2370, 2009), which was downloaded from NCBI with the accession SRA002775; (2) human gut metagenomic data from Japanese individuals (Kurokawa et al., DNA Res. 14: 169-181, 2007), which was downloaded from P. Bork's group at EMBL (http://www.bork.embl.de). The integrated NR database we constructed in this study included NCBI-NR database (version April 2009) and all genes from the known human gut bacteria genomes.

Illumina GA Short Reads De Novo Assembly.

High-quality short reads of each DNA sample were assembled by the SOAP de novo assembler (Li. & Zhu, Genome Res., 20(2): 265-272, 2010). In brief, we first filtered the low abundant sequences from the assembly according to 17-mer frequencies The 17-mers with depth less than 5 were screened in front of assembly, for these low-frequency sequences were very unlikely to be assembled, whereas removing them would significantly reduce memory requirement and make assembly feasible in an ordinary supercomputer (512 GB memory in our institute). Then the sequences were processed one by one and the de Bruijn graph data format was used to store the overlap information among the sequences. The overlap paths supported by a single read were unreliable and removed. Short low-depth tips and bubbles that were caused by sequencing errors or genetic variations between microbial strains were trimmed and merged, respectively. Read paths were used to solve the tiny repeats. Finally, we broke the connections at repeat boundaries, and outputted the continuous sequences with unambiguous connections as contigs. The metagenomic special model was chosen, and parameters ‘-K 21’ and ‘-K 23’ were used for 44 by and 75 by reads, respectively, to indicate the minimal sequence overlap required. After de novo assembly for each sample independently, we merged all the unassembled reads together and performed assembly for them, as to maximize the usage of data and assemble the microbial genomes that have low frequency in each read set, but have sufficient sequence depth for assembly by putting the data of all samples together.

Validating Illumina Contigs Using Sanger Reads.

We used BLASTN (WUBLAST 2.0) to map Sanger reads from samples MH0006 and MH0012 (156.9 Mb and 154.7 Mb, respectively) to Illumina contigs (single best hit longer than 75 by and over 95% identity) from the same samples. Each alignment was scanned for breakage of collinearity where both sequences have at least 50 bases left unaligned at one end of the alignment. Each such breakage was considered an assembly error in the Illumina contig at the location where collinearity breaks. Errors within 30 by from each other were merged. An error was discarded if there exists a Sanger read that agrees with the contig structure for 60 by on both sides of the error. For comparison, we repeated this on a Newbler2 assembly of 454 Titanium reads from MH0006 (550 Mb reads). We estimate 14.12 errors per Mb of contigs for the Illumina assembly, which is comparable to that of the 454 assembly (20.73 per Mb). 98.7% of Illumina contigs that map at least one Sanger read were collinear over 99.55% of the mapped regions, which is comparable to 97.86% of such 454 contigs being collinear over 99.48% of the mapped regions.

Evaluation of Human Gut Microbiome Coverage.

The Illumina GA reads were aligned against the assembled contigs and known bacteria genomes using SOAP by allowing at most two mismatches in the first 35-bp region and 90% identity over the read sequence. The Roche/454 and Sanger sequencing reads were aligned against the same reference using BLASTN with 1×10⁻⁸, over 100 by alignment length and minimal 90% identity cutoff. Two mismatches were allowed and identity was set 95% over the read sequence when aligned to the GA reads of MH0006 and MH0012 to Sanger reads from the same samples by SOAP.

Gene Prediction and Construction of the Non-Redundant Gene Set.

We use MetaGene (Noguchi et al., Nucleic Acids Res., 34, 5623-5630, 2006)—which uses di-codon frequencies estimated by the GC content of a given sequence, and predicts a whole range of ORFs based on the anonymous genomic sequences—to find ORFs from the contigs of each of the 124 samples as well as the contigs from the merged assembly. The predicted ORFs were then aligned to each other using BLAT (Kent et al., Genome Res., 12: 656-664, 2002). A pair of genes with greater than 95% identity and aligned length covered over 90% of the shorter gene was grouped together. The groups sharing genes were then merged, and the longest ORF in each merged group was used to represent the group, and the other members of the group were taken as redundancy. Therefore, we organized the non-redundant gene set from all the predicted genes by excluding the redundancy. Finally, the ORFs with length less than 100 by were filtered. We translated the ORFs into protein sequences using the NCBI Genetic Codes (Ley et al., Nature Rev. Microbiol., 6: 776-788, 2008).

Identification of Genes.

To make a balance between identifying low-abundance genes and reducing the error-rate of identification, we explored the impact of the threshold set for read coverage required to identify a gene in individual microbiomes. The number of genes decreased about twice when the number of reads required for identification was increased from 2 to 6, and changed slowly thereafter. Nevertheless, to include the rare genes into the analysis, we selected the threshold of 2 reads.

Gene Taxonomic Assignment.

Taxonomic assignment of predicted genes was carried out using BLASTP alignment against the integrated NR database. BLASTP alignment hits with e-values larger than 1×10⁻⁵ were filtered, and for each gene the significant matches which were defined by e-values<10×e-value of the top hit were retained to distinguish taxonomic groups. Then we determined the taxonomical level of each gene by the lowest common ancestor (LCA)-based algorithm that was implemented in MEGAN (Huson et al., Genome Res., 17: 377-386, 2007). The LCA-based algorithm assigns genes to taxa in the way that the taxonomical level of the assigned taxon reflects the level of conservation of the gene. For example, if a gene was conserved in many species, it was assigned to the LCA rather than to a species.

Gene Functional Classification.

We used BLASTP to search the protein sequences of the predicted genes in the eggNOG database (Jensen et al., Nucleic Acids Res., 36: D250-D254, 2008) and KEGG database (Kanehisa et al., Nucleic Acids Res., 32: D277-D280, 2004) with e-value<1×10⁻⁵. The genes were annotated as the function of the NOGs or KEGG homologues with lowest e-value. The eggNOG database is an integration of the COG and KOG databases. The genes annotated by COG were classified into the 25 COG categories, and genes that were annotated by KEGG were assigned into KEGG pathways.

Determination of Minimal Gut Bacterial Genome.

The number of non-redundant genes assigned to the eggNOG clusters was normalized by gene length and cluster copy number. The clusters were ranked by normalized gene number and the range that included the clusters encoding essential Bacillus subtilis genes was determined, computing the proportion of these clusters among the successive groups of 100 clusters. Analysis of the range gene clusters involved, besides iPath projections, use of KEGG and manual verification of the completeness of the pathways and protein machineries they encode.

Determination of Total Functional Complement and Minimal Metagenome.

We computed the total and shared number of orthologous groups and/or gene families present in random combinations of n individuals (with n=52 to 124, 100 replicates per bin). This analysis was performed on three groups of gene clusters: (1) known eggNOG orthologous groups (that is, those with functional annotation, excluding those in which the terms [Uu]ncharacteri[sz] ed, [Uu]nknown, [Pp]redicted or [Pp]utative occurred); (2) all eggNOG orthologous groups; (3) all orthologous groups plus gene families constructed from remaining genes not assigned to the two above categories. Families were clustered from all-against-all BLASTP results using MCL (van Dongen, Ph. D. Thesis, Univ. Utrecht, 2000) with an inflation factor of 1.1 and a bit-score cutoff of 60.

Rarefaction Analysis.

Estimation of total gene richness was done using EstimateS on 100 randomly picked samples due to memory limitations. Because the CV value was >0.5, both chao2 (classic) and ICE richness estimators were calculated and the larger estimate of the two (ICE) was used. The estimate for this sample size was 3,621,646 genes (ICE) whereas S_{obs} (Mao Tau) was 3,090,575 genes, or 85.3%. The ICE estimator curve did not completely saturate, indicating that additional samples will need to be added to achieve a final, conclusive estimate.

Common Bacterial Core.

To eliminate the influence of very similar strains and assess the presence of known microbial species among the individuals of the cohort, we used 650 sequenced bacterial and archaeal genomes as a reference set. The set was composed from 932 publicly available genomes, which were grouped by similarity, using a 90% identity cutoff and the similarity over at least 80% of the length. From each group only the largest genome was used. Illumina reads from 124 individuals were mapped to the set, for species profiling analysis and the genomes originating from the same species (by differing in size >20%) curated by manual inspection and by using the 16S-based clustering when the sequences were available.

Relative Abundance of Microbial Genomes Among Individuals.

We computed the genome coverage by uniquely mapping Illumina reads and normalized it to 1 Gb of sequence, to correct for different sequencing levels in different individuals. The coverage was summed over all species of the non-redundant bacterial genome set for each individual and the proportion of each species relative to the sum calculated.

Species Co-Existence Network.

For the 155 species that had genome coverage by the Illumina reads ≧1% in at least one individual we calculated the pair-wise inter-species Pearson correlations between sequencing depths (abundance) throughout the entire cohort of 124 individuals. From the resulting 11,175 inter-species correlations, correlations less than −0.4 or above 0.4 (n=342) were visualized in a graph using Cytoscape (Shannon et al., Genome Res. 13: 2498-2504, 2003). displaying the average genome coverage of each species as node size in the graph.

### Results

A Summary Description of the Cohort & the Method Used.

A total of 177 Danish individuals were studied. They comprised 67 people with a BMI<27.5 (lean, healthy controls) and 110 individuals with a BMI>27.5 (obese patients). The entire gene catalog of 3.3 million genes was searched by ranksum search for those that are significantly different between the two groups. Gene frequency was normalized by the gene size (larger genes are bigger targets and are seen more often) and the difference in the sequencing extent for different individuals. The number of significantly different genes is affected by the thresholds and the splits into groups. In brief, 1327 “BMI-related genes” (also referred to herein as BMI genes) were found at p<10⁻⁴.

Overall Analysis of the BMI Genes.

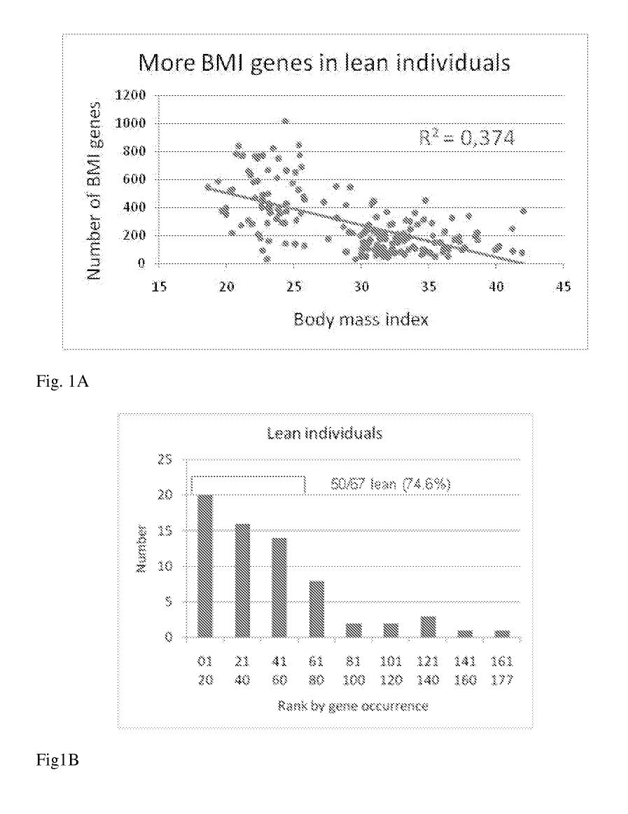

The significantly different genes, i.e. BMI-related genes, were plotted by individual (FIG. 1A). The median number of BMI genes in a healthy individual was 476, and only 179 in an obese patient. The median gene number is very significantly different among the 2 groups (p<10⁻¹⁷, one-tailed t test). When the genes were ranked by gene number and binned by groups of 20, 50 individuals out of 67 were in the first three bins, illustrating that lean individuals are at the top of the distribution (FIG. 1B).

Comparison of the Distribution of All Genes and BMI Genes.

The distribution of all genes of the microbiome and of the BMI genes was compared. There is much less difference in all gene numbers and frequency between the two groups than the BMI genes. The BMI gene distribution does not reflect simply the all gene distribution. The loss of genes in the obese patients is thus significant.

BMI-Related Species.

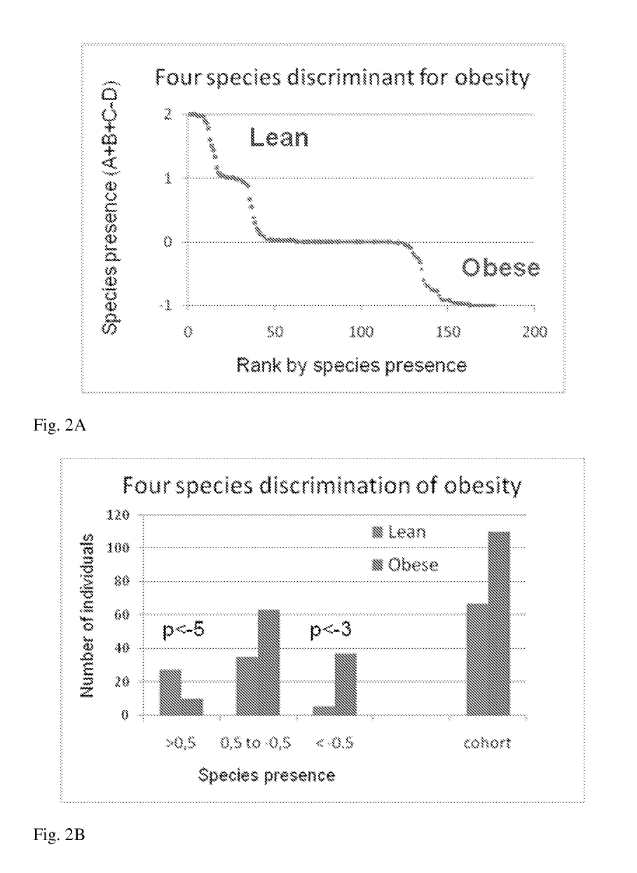

The BMI genes were allocated to species, using the taxonomic assignments attributed to the genes in the 3.3 million catalog (Qin et al., Nature, 2010, in press, doi:10.1038/nature08821). It was found that 59.8% of the BMI genes, but only 32.8% of all genes, were from Firmicutes. On the other hand, the frequency of Bacteroidetes was 8.1% for BMI genes and 18.4% for all the genes of the microbiome. Therefore, obesity is associated to changes in Firmicutes. The species were first identified by the number of genes assigned to them amongst the BMI genes. Then other genes from the same species were pulled out of the catalog and the presence of 50 representative genes for each species assessed in different individuals (this compared very favorably with the use of a single 16S gene, which is currently done to identify a species). The species was considered present if at least half of the marker genes were found in an individual. The significance of the distribution between the healthy and the patients was estimated by the comparison with the all cohort distribution (67 to 110) using the Chi2 test. Bacteronides pectinophilus, Eubacterium siraeum and Clostridium phyto fermentans were associated with the healthy population (p=2.1×10⁻³, p=3.5×10⁻⁴, and p=6.1×10⁻⁴, respectively), i.e. they tended to be absent from the obese patients. On the other hand, Anaerotruncus colihominis was associated with the patient cohort (p=1.4×10⁻²). On the basis of the identification of species, it was demonstrated that the linear combination of these 4 species fully predicts the obesity phenotype (FIG. 2A). Healthy individuals and patients are shown as blue and red dots, respectively. The species presence (the ordinate) corresponds to the sum of the genes the of “good species” (anti-associated with obesity) minus the genes of the “bad species” (associated with obesity). The individuals are ranked by the species presence (the abscissa). If an individual has excess of the “good species” genes, he or she will be on the top of the rank and tend to be healthy, while if there is an excess of “bad species” genes, he or she will be at the right and tend to be sick. This is also illustrated in FIG. 2B, with groups of individuals having at least half of the genes of good species in excess to the bad or half of the genes of a bad species in excess to good (cutoffs>0.5 & <−0.5, respectively). The distribution of individuals is indicated by red and blue bars and the probability of the distributions (Chi2) shown above the two significantly different groups. The cohort composition is shown for comparison. The accuracy of discrimination is computed as correctly vs incorrectly classified individuals (correct 64, false 15).

TABLE 1
BMI genes

| ID | NOG | KO | Map | Name(NR) |
|---|---|---|---|---|
| 6902 | COG3451 | NA | NA | Faecalibacterium prausnitzii |
| 9549 | NA | NA | NA | — |
| 10658 | NA | NA | NA | — |
| 11041 | COG0048 | K02950 | NA | Bacteroidales |
| 11459 | COG0708 | K01142 | map03410 | Eubacterium ventriosum |
| 12798 | NA | NA | NA | Bacteria |
| 13291 | NA | NA | NA | Alistipes putredinis |
| 14497 | NA | NA | NA | — |
| 15094 | COG3451 | NA | NA | Clostridium leptum |
| 16910 | NA | NA | NA | — |
| 19436 | COG1506 | K01278 | NA | Alistipes putredinis |
| 22100 | NA | NA | NA | — |
| 39244 | NA | K02014 | NA | Bacteroides ovatus |
| 49082 | COG1301 | NA | NA | Bacteroidales |
| 50933 | COG2384 | K06967 | NA | Faecalibacterium prausnitzii |
| 52448 | COG2407 | NA | NA | — |
| 52602 | COG0706 | K03217 | NA | Faecalibacterium prausnitzii |
| 62609 | COG2070 | K00459 | map00910 | Cupriavidus pinatubonensis |
| 62613 | COG1960 | K00248 | map00071 | Anaerostipes caccae |
| 62614 | COG2086 | K03521 | NA | Eubacterium hallii |
| 72965 | COG2256 | K07478 | NA | Clostridium cellulolyticum |
| 73911 | NA | NA | NA | Clostridium cellulolyticum |
| 79540 | NA | NA | NA | Clostridium |
| 88849 | NOG09739 | NA | NA | Clostridiales |
| 90256 | COG0050 | K02358 | NA | Desulfovibrio piger |
| 91577 | COG0504 | K01937 | map00240 | Alistipes putredinis |
| 115552 | NA | K03046 | map03020 | Bacteroides capillosus |
| 115887 | NA | NA | NA | — |
| 116445 | NA | NA | NA | — |
| 119925 | NA | K03088 | NA | Clostridium asparagiforme |
| 119929 | NA | NA | NA | — |
| 122057 | NA | NA | NA | Caldicellulosiruptor saccharolyticus |
| 122061 | NA | K10188 | NA | Anaerocellum thermophilum |
| 122064 | NA | NA | NA | — |
| 133411 | NA | NA | NA | — |
| 133755 | NA | NA | NA | — |
| 136583 | NOG17478 | NA | NA | Clostridiales |
| 137542 | NA | NA | NA | — |
| 138082 | COG0582 | K04763 | NA | Firmicutes |
| 146660 | NA | K02035 | NA | Anaerococcus hydrogenalis |
| 162617 | COG0270 | K00558 | map00271 | Bacteroides pectinophilus |
| 173708 | NA | NA | NA | — |
| 174206 | COG5504 | NA | NA | Clostridium difficile |
| 175969 | COG1475 | K03497 | NA | — |
| 224681 | COG0178 | K03701 | NA | Bacteroides capillosus |
| 225907 | COG0592 | K02338 | map03030 | Bacteroides capillosus |
| 225953 | COG0231 | K02356 | NA | Desulfitobacterium hafniense |
| 234271 | COG0024 | K01265 | NA | Bacteroides capillosus |
| 235177 | COG0564 | K06179 | NA | Bacteroides capillosus |
| 242887 | NA | NA | NA | — |
| 246223 | COG0358 | K02316 | map03030 | Heliobacterium modesticaldum |
| 246224 | COG0305 | K01529 | map00790 | Clostridiales |
| 250611 | COG0860 | NA | NA | Anaerofustis stercorihominis |
| 265214 | COG3956 | K02499 | NA | Bacteria |
| 278309 | NA | NA | NA | Clostridium bartlettii |
| 283745 | COG0756 | K01520 | map00240 | Clostridium |
| 285668 | NA | NA | NA | — |
| 298274 | NA | NA | NA | Coprococcus comes |
| 307613 | COG1269 | NA | NA | Dorea formicigenerans |
| 308567 | COG1879 | NA | NA | Clostridiales |
| 308629 | NA | NA | NA | Clostridium bolteae |
| 311862 | COG0440 | NA | NA | Bacteroides capillosus |
| 313271 | NA | NA | NA | — |
| 319760 | NA | K01273 | NA | Clostridium difficile |
| 322345 | NA | NA | NA | Anaerotruncus colihominis |
| 327975 | COG3505 | K03205 | NA | Clostridiales |
| 330101 | COG0766 | K00790 | map00530 | Bacteria |
| 330692 | COG4717 | NA | NA | Clostridium perfringens |
| 336242 | COG0548 | K00930 | map00220 | — |
| 338413 | COG2323 | NA | NA | Clostridium |
| 339122 | NA | NA | NA | — |
| 340553 | COG2972 | K07704 | map02020 | Clostridium hylemonae |
| 342386 | NOG06096 | NA | NA | Clostridium |
| 342915 | COG0584 | K01126 | map00564 | Firmicutes |
| 347956 | COG1126 | K10038 | map02010 | Bacteria |
| 350967 | COG4905 | K06950 | NA | Clostridiales |
| 358755 | NOG06495 | NA | NA | Coprococcus comes |
| 359744 | COG3959 | K00615 | map00030 | Clostridiales |
| 360143 | COG0188 | K02469 | NA | Bacteria |
| 376654 | COG1725 | K07979 | NA | Clostridiales |
| 379402 | COG0787 | K01775 | map00252 | Clostridium phytofermentans |
| 410894 | COG0542 | NA | NA | Bacteria |
| 447063 | NA | NA | NA | Ruminococcus lactaris |
| 450567 | COG2071 | K07010 | NA | Clostridium bolteae |
| 457960 | COG0351 | K00877 | map00730 | Faecalibacterium prausnitzii |
| 457996 | COG0491 | NA | NA | Faecalibacterium prausnitzii |
| 458062 | COG1702 | NA | NA | Faecalibacterium prausnitzii |
| 458092 | COG1109 | K03431 | map00530 | Faecalibacterium prausnitzii |
| 458657 | COG0368 | K02233 | map00860 | Faecalibacterium prausnitzii |
| 458959 | COG2267 | K01048 | map00564 | Faecalibacterium prausnitzii |
| 458961 | COG0561 | K07024 | NA | Faecalibacterium prausnitzii |
| 459167 | COG2239 | NA | NA | Faecalibacterium prausnitzii |
| 459170 | COG1362 | K01267 | NA | — |
| 459293 | COG1284 | NA | NA | Faecalibacterium prausnitzii |
| 460879 | COG1197 | K03723 | map03420 | Faecalibacterium prausnitzii |
| 461115 | COG0144 | K03500 | NA | Faecalibacterium prausnitzii |
| 461216 | COG0419 | K03546 | NA | Faecalibacterium prausnitzii |
| 462093 | COG0039 | K00016 | map00010 | Roseburia inulinivorans |
| 462145 | COG0635 | K02495 | map00860 | Faecalibacterium prausnitzii |
| 462320 | COG3279 | NA | NA | — |
| 466171 | NA | NA | NA | Clostridiales |
| 466172 | COG3505 | K03205 | NA | Bacteria |
| 482432 | NA | NA | NA | Clostridium butyricum |
| 483703 | COG0080 | K02867 | NA | Clostridium |
| 488420 | NA | NA | NA | — |
| 489505 | NA | NA | NA | Coprococcus eutactus |
| 497277 | COG2706 | K01057 | map00030 | Clostridium |
| 527922 | COG1653 | K10117 | NA | — |
| 530930 | NA | NA | NA | — |
| 546887 | NA | NA | NA | — |
| 553803 | NA | K07216 | NA | Roseburia inulinivorans |
| 568486 | COG4219 | K02547 | NA | Clostridium |
| 569928 | NA | NA | NA | — |
| 569929 | NA | NA | NA | Haemophilus influenzae |
| 570360 | COG0277 | K00104 | map00630 | Bacteria |
| 576044 | NA | NA | NA | — |
| 577683 | NOG25439 | NA | NA | Pedobacter |
| 580103 | COG0648 | K01151 | map03410 | Faecalibacterium prausnitzii |
| 594250 | COG1695 | K10947 | NA | Eubacterium siraeum |
| 594682 | NA | NA | NA | Eubacterium siraeum |
| 594949 | COG2050 | K02614 | NA | Eubacterium siraeum |
| 595409 | COG1687 | NA | NA | Eubacterium siraeum |
| 595644 | NA | NA | NA | Eubacterium siraeum |
| 596031 | COG3843 | NA | NA | Bacteroides pectinophilus |
| 596742 | COG0834 | K02030 | NA | Eubacterium siraeum |
| 596786 | COG1551 | K03563 | NA | Eubacterium siraeum |
| 596787 | COG1699 | NA | NA | Eubacterium siraeum |
| 598043 | NA | NA | NA | — |
| 598171 | COG1360 | K02557 | NA | Eubacterium siraeum |
| 598533 | COG0055 | K02112 | map00190 | Chthoniobacter flavus |
| 598878 | NA | NA | NA | — |
| 599210 | NA | NA | NA | Eubacterium siraeum |
| 613127 | NA | NA | NA | Clostridium phytofermentans |
| 618702 | NA | NA | NA | Mesoplasma forum |
| 618916 | NA | NA | NA | Bacteroides intestinalis |
| 670852 | COG0265 | K01362 | NA | Clostridium asparagiforme |
| 684780 | COG0367 | K01953 | map00252 | Desulfovibrio desulfuricans |
| 694886 | COG1876 | K07260 | NA | Clostridium thermocellum |
| 726129 | COG0196 | K00861 | map00740 | Faecalibacterium prausnitzii |
| 735834 | COG4804 | NA | NA | Roseburia inulinivorans |
| 740278 | COG3177 | NA | NA | Clostridium leptum |
| 744341 | COG1070 | K00854 | map00040 | Clostridia |
| 744429 | COG0790 | K07126 | NA | Candidatus Amoebophilus asiaticus |
| 745495 | NA | NA | NA | — |
| 747791 | COG0493 | K00266 | NA | Firmicutes |
| 749395 | COG0426 | K00540 | NA | Clostridium |
| 749585 | COG1219 | K03544 | NA | Clostridium phytofermentans |
| 750039 | COG0201 | K03076 | NA | Clostridium phytofermentans |
| 750165 | NA | NA | NA | — |
| 750765 | COG0448 | K00975 | map00500 | Clostridium bolteae |
| 750767 | COG0448 | K00975 | map00500 | Coprococcus comes |
| 752580 | COG1293 | NA | NA | Clostridiales |
| 752649 | COG0465 | K03798 | NA | Blautia hydrogenotrophica |
| 753326 | COG0540 | K00609 | map00240 | Ruminococcus torques |
| 754420 | COG1966 | K06200 | NA | Bacteria |
| 754646 | COG2205 | K07646 | map02020 | Clostridium |
| 754647 | COG1283 | K03324 | NA | Bacteroides capillosus |
| 755381 | COG0568 | K03086 | NA | Clostridiales |
| 756805 | COG0436 | K00821 | map00300 | Eubacterium ventriosum |
| 758713 | COG0743 | K00099 | map00100 | Ruminococcus torques |
| 758854 | COG0452 | K06411 | NA | Clostridium phytofermentans |
| 760259 | COG0583 | K05817 | NA | Clostridium hiranonis |
| 760836 | COG2217 | K01534 | NA | Bacteria |
| 761022 | COG1879 | K10439 | NA | Thermoanaerobacter tengcongensis |
| 761910 | NA | NA | NA | — |
| 763343 | NA | NA | NA | Collinsella stercoris |
| 763741 | COG2873 | K01740 | map00271 | Ruminococcus obeum |
| 763946 | COG0840 | K03406 | NA | Heliobacterium modesticaldum |
| 764336 | COG1928 | K00728 | map01030 | — |
| 765330 | COG1109 | K01840 | map00051 | Clostridiales |
| 766445 | COG2966 | NA | NA | Dorea formicigenerans |
| 767171 | COG0608 | K07462 | map03410 | Clostridium phytofermentans |
| 768679 | COG2385 | K06381 | NA | Clostridium phytofermentans |
| 768969 | COG3426 | K00929 | map00650 | Clostridiales |
| 769544 | COG3842 | K02052 | map02010 | Anaerofustis stercorihominis |
| 769550 | NA | NA | NA | — |
| 771102 | COG3321 | K10817 | map00522 | Bacteria |
| 772837 | COG2755 | K01045 | map00363 | Dorea longicatena |
| 772842 | NA | NA | NA | Clostridium phytofermentans |
| 775519 | COG2265 | K00599 | map00150 | Eubacterium siraeum |
| 776996 | COG0825 | K01962 | map00061 | Eubacterium siraeum |
| 778526 | COG0085 | K03043 | map03020 | Clostridia |
| 783883 | COG2730 | K01179 | map00500 | Eubacterium siraeum |
| 784098 | COG0144 | K03500 | NA | — |
| 784499 | NA | NA | NA | — |
| 786679 | COG3291 | NA | NA | Eubacterium siraeum |
| 787080 | COG4625 | NA | NA | Eubacterium siraeum |
| 790377 | NA | NA | NA | Eubacterium siraeum |
| 791889 | NA | NA | NA | Eubacterium siraeum |
| 791890 | COG1472 | K01207 | map00511 | Eubacterium siraeum |
| 792637 | COG0366 | K01200 | NA | Eubacterium siraeum |
| 793094 | COG0840 | K03406 | NA | Eubacterium siraeum |
| 793149 | NA | NA | NA | Eubacterium siraeum |
| 793469 | NA | NA | NA | Eubacterium siraeum |
| 794741 | NA | NA | NA | — |
| 796765 | COG1132 | K06147 | NA | Eubacterium siraeum |
| 797076 | COG0657 | K01181 | NA | Eubacterium siraeum |
| 797363 | COG3279 | K07705 | NA | Eubacterium siraeum |
| 806068 | COG0500 | K00599 | map00150 | Bacteroides |
| 806228 | COG0547 | K00766 | map00400 | Bacteroides intestinalis |
| 807174 | NOG23778 | NA | NA | Faecalibacterium prausnitzii |
| 809707 | COG4716 | K10254 | NA | Faecalibacterium prausnitzii |
| 809761 | NA | NA | NA | — |
| 809996 | COG4988 | K06148 | NA | Bacteria |
| 833652 | NA | NA | NA | — |
| 833787 | COG0328 | NA | NA | Clostridiales |
| 833925 | COG0841 | NA | NA | Bacteroides |
| 834204 | COG1052 | K03778 | map00620 | Clostridium phytofermentans |
| 834225 | COG0671 | NA | NA | Faecalibacterium prausnitzii |
| 834606 | COG0499 | NA | NA | cellular organisms |
| 834613 | NA | NA | NA | — |
| 834703 | NA | NA | NA | — |
| 834818 | NOG13134 | NA | NA | Faecalibacterium prausnitzii |
| 835107 | COG1396 | NA | NA | Clostridium |
| 835438 | COG1126 | K02028 | map02010 | Clostridium |
| 835458 | COG0459 | K04077 | NA | Clostridium methylpentosum |
| 836015 | NA | NA | NA | Clostridium leptum |
| 836097 | COG1269 | NA | NA | Clostridium hiranonis |
| 836212 | NA | NA | NA | Eubacterium ventriosum |
| 836262 | COG1193 | NA | NA | Faecalibacterium prausnitzii |
| 836651 | COG1010 | K05934 | map00860 | — |
| 836682 | NA | NA | NA | Alistipes putredinis |
| 836735 | COG0406 | K01834 | map00010 | Clostridium leptum |
| 836767 | COG2217 | NA | NA | Eubacterium siraeum |
| 837316 | COG0012 | NA | NA | Roseburia inulinivorans |
| 837359 | NA | NA | NA | Trichomonas vaginalis |
| 837728 | COG1199 | NA | NA | Faecalibacterium prausnitzii |
| 837740 | NA | NA | NA | — |
| 838374 | COG1473 | K01302 | NA | Faecalibacterium prausnitzii |
| 838524 | COG1274 | NA | NA | Anaerotruncus colihominis |
| 838525 | COG0460 | K00003 | map00260 | Bacteria |
| 838528 | COG5427 | NA | NA | Ruminococcus obeum |
| 838721 | inNOG06326 | NA | NA | — |
| 839454 | COG4905 | NA | NA | Faecalibacterium prausnitzii |
| 839475 | COG3250 | K01190 | map00052 | Caulobacter |
| 839558 | NA | NA | NA | — |
| 839671 | COG0481 | K03596 | NA | Eubacterium siraeum |
| 839772 | COG1316 | NA | NA | Clostridia |
| 839773 | COG1713 | K00969 | map00760 | Clostridium acetobutylicum |
| 839849 | COG3664 | K01198 | map00500 | — |
| 840036 | COG0301 | K03151 | NA | Bacteria |
| 840300 | COG0220 | K03439 | NA | Lactobacillus |
| 840950 | COG0188 | NA | NA | Ruminococcus obeum |
| 841058 | COG4660 | K03613 | NA | Bacteria |
| 841336 | COG1454 | K00048 | map00620 | Clostridiales |
| 841501 | COG1475 | NA | NA | Faecalibacterium prausnitzii |
| 841687 | NA | NA | NA | — |
| 841753 | COG0151 | K01945 | map00230 | — |
| 842017 | COG0116 | K07444 | NA | Clostridium leptum |
| 842122 | COG0550 | NA | NA | Bacteroides capillosus |
| 842614 | NA | NA | NA | Alistipes putredinis |
| 842632 | NOG08575 | K06012 | NA | Faecalibacterium prausnitzii |
| 842665 | COG2002 | K06284 | NA | Clostridia |
| 842686 | NA | NA | NA | Gramella forsetii |
| 842874 | COG0768 | NA | NA | Faecalibacterium prausnitzii |
| 844031 | COG0206 | K03531 | NA | Clostridiales |
| 844100 | COG0500 | K00599 | map00150 | Clostridium thermocellum |
| 844355 | COG1027 | K01744 | map00252 | Clostridium |
| 844356 | COG3968 | NA | NA | Ruminococcus torques |
| 844453 | NA | NA | NA | — |
| 845074 | COG0673 | NA | NA | Elusimicrobium minutum |
| 845221 | COG0673 | K00010 | map00031 | — |
| 845450 | NOG23148 | NA | NA | Clostridiales |
| 846226 | COG0474 | NA | NA | Alkaliphilus oremlandii |
| 846787 | COG0577 | NA | NA | Clostridium scindens |
| 847523 | COG0242 | K01462 | NA | Clostridiales |
| 847584 | NA | NA | NA | — |
| 848434 | COG0842 | NA | NA | Roseburia inulinivorans |
| 848669 | COG3595 | NA | NA | Coprococcus eutactus |
| 849537 | COG1066 | K04485 | NA | Clostridium methylpentosum |
| 850244 | COG1195 | NA | NA | Bacteroides capillosus |
| 851009 | COG0571 | K03685 | NA | Desulfococcus oleovorans |
| 851397 | COG0474 | K01529 | map00790 | Alkaliphilus oremlandii |
| 851657 | COG3225 | NA | NA | Clostridia |
| 852404 | NA | NA | NA | Lactobacillus delbrueckii |
| 852468 | NOG16527 | NA | NA | Bacteria |
| 854401 | NA | NA | NA | — |
| 854796 | COG4468 | K00964 | map00052 | Clostridium |
| 855213 | COG3250 | K01190 | map00052 | Clostridium |
| 855302 | NA | NA | NA | Clostridium methylpentosum |
| 857096 | COG2017 | K01785 | map00010 | Clostridium phytofermentans |
| 857138 | COG2207 | K02099 | NA | Clostridium |
| 857370 | COG3250 | K01190 | map00052 | Roseburia inulinivorans |
| 858607 | COG1766 | NA | NA | Bacteroides pectinophilus |
| 859820 | COG0064 | NA | NA | Clostridiales |
| 859950 | COG2211 | K03292 | NA | Clostridium |
| 859951 | COG3250 | K01190 | map00052 | Clostridium |
| 860475 | COG0530 | K07301 | NA | Eubacterium hallii |
| 862083 | COG0188 | NA | NA | Clostridiales |
| 865365 | COG0060 | NA | NA | Bacteria |
| 865485 | COG0765 | K02029 | NA | Clostridium kluyveri |
| 865516 | COG0606 | K07391 | NA | Clostridium phytofermentans |
| 866708 | COG0414 | K01918 | map00410 | Eubacterium ventriosum |
| 868899 | COG4468 | K00964 | map00052 | Clostridium |
| 868900 | COG1087 | K01784 | map00052 | Clostridium |
| 868901 | COG1087 | K01784 | map00052 | Bacteria |
| 869383 | COG0642 | K10819 | NA | Clostridium phytofermentans |
| 870033 | COG0809 | K07568 | NA | Clostridiales |
| 870115 | COG0366 | NA | NA | Streptomyces griseus |
| 870661 | COG0172 | K01875 | map00260 | Eubacterium ventriosum |
| 870671 | COG0571 | K03685 | NA | Clostridium phytofermentans |
| 870965 | NA | NA | NA | Clostridium phytofermentans |
| 871372 | COG0840 | K03406 | NA | — |
| 871460 | COG2182 | K10108 | NA | — |
| 871577 | COG3894 | NA | NA | Desulfitobacterium hafniense |
| 872731 | COG2207 | K01198 | map00500 | — |
| 874171 | COG0334 | K00262 | map00251 | Bacteroides |
| 874355 | COG2017 | K01785 | map00010 | Bacteroides |
| 876282 | COG0046 | K01952 | map00230 | Bacteroides capillosus |
| 876821 | COG0845 | K03585 | NA | Bacteroides |
| 889374 | COG3451 | NA | NA | Bacteroides |
| 896511 | COG0078 | K00611 | map00220 | Faecalibacterium prausnitzii |
| 896614 | KOG2239 | NA | NA | — |
| 896936 | COG1883 | K01605 | map00640 | Alistipes putredinis |
| 897489 | NA | NA | NA | — |
| 898035 | NA | NA | NA | Lachnospiraceae |
| 899154 | NOG13698 | NA | NA | Bacteria |
| 899650 | COG0119 | K01649 | map00290 | Opitutus terrae |
| 900518 | COG1178 | NA | NA | Bacteria |
| 900813 | COG0138 | K00602 | map00230 | Bacteroides capillosus |
| 901388 | COG0406 | NA | NA | Hyphomonas neptunium |
| 901806 | NA | NA | NA | Bacteroides intestinalis |
| 902420 | COG1033 | K07003 | NA | — |
| 904007 | NA | NA | NA | Clostridiales |
| 904792 | NA | NA | NA | — |
| 905909 | COG1132 | K06147 | NA | Bacteroides pectinophilus |
| 906112 | NA | NA | NA | — |
| 908294 | NA | NA | NA | — |
| 912704 | COG1373 | K07133 | NA | — |
| 915416 | COG0153 | K00849 | map00052 | Clostridium |
| 921992 | COG0745 | K02483 | NA | Clostridium nexile |
| 924353 | COG0137 | K01940 | map00220 | Clostridiales |
| 926510 | COG2755 | K01045 | map00363 | Faecalibacterium prausnitzii |
| 927762 | NA | NA | NA | — |
| 927763 | NA | NA | NA | — |
| 929559 | COG0318 | NA | NA | Clostridiales |
| 929923 | COG1686 | NA | NA | Faecalibacterium prausnitzii |
| 930053 | COG0765 | NA | NA | Faecalibacterium prausnitzii |
| 930728 | COG3968 | K01915 | map00251 | Firmicutes |
| 932117 | COG0841 | K03296 | NA | Faecalibacterium prausnitzii |
| 932464 | COG0587 | NA | NA | Bacteria |
| 933417 | COG3345 | NA | NA | Clostridiales |
| 934370 | COG0077 | NA | NA | Eubacterium siraeum |
| 935356 | COG0458 | K01955 | map00240 | Firmicutes |
| 936472 | COG1117 | K02036 | map02010 | Faecalibacterium prausnitzii |
| 936622 | NA | NA | NA | Alistipes putredinis |
| 938652 | COG0726 | NA | NA | Eubacterium siraeum |
| 939740 | COG0716 | NA | NA | Clostridium methylpentosum |
| 940643 | COG1968 | NA | NA | Eubacterium siraeum |
| 940817 | NA | NA | NA | Methanococcus maripaludis |
| 940884 | COG0726 | K01463 | NA | Eubacterium siraeum |
| 941318 | COG1847 | K06346 | NA | Eubacterium siraeum |
| 941772 | COG2972 | K07701 | map02020 | Faecalibacterium prausnitzii |
| 942695 | COG0159 | NA | NA | Clostridium leptum |
| 942777 | NA | NA | NA | Eubacterium siraeum |
| 943861 | COG0542 | K03695 | NA | Eubacterium siraeum |
| 943984 | COG1968 | K06153 | map00550 | Alistipes putredinis |
| 945128 | COG1028 | K00065 | map00040 | Clostridium |
| 945475 | COG3707 | K07183 | NA | Faecalibacterium prausnitzii |
| 946374 | COG0077 | K04093 | map00400 | Faecalibacterium prausnitzii |
| 949511 | NA | NA | NA | Eubacterium siraeum |
| 949649 | COG0009 | K07566 | NA | Eubacterium siraeum |
| 949751 | NOG21955 | NA | NA | Eubacterium siraeum |
| 950385 | NA | NA | NA | — |
| 951511 | COG1589 | NA | NA | Eubacterium siraeum |
| 953454 | NA | NA | NA | — |
| 954390 | COG0725 | K02020 | NA | Clostridiales |
| 957601 | COG3209 | NA | NA | Bacteroides |
| 967219 | NA | NA | NA | — |
| 971723 | COG0291 | K02916 | NA | Gloeobacter violaceus |
| 971738 | COG3291 | K01448 | map00550 | Trichomonas vaginalis |
| 973942 | NOG16846 | NA | NA | Roseburia inulinivorans |
| 976902 | COG0687 | K11069 | NA | — |
| 978507 | COG0049 | K02992 | NA | Anaerotruncus colihominis |
| 978945 | COG0268 | K02968 | NA | Clostridium |
| 979183 | NA | NA | NA | — |
| 980554 | COG1866 | K01610 | map00020 | Bacteria |
| 981538 | NA | NA | NA | Anaerofustis stercorihominis |
| 981673 | NA | NA | NA | — |
| 983563 | NA | NA | NA | — |
| 983987 | COG1653 | NA | NA | Bifidobacterium adolescentis |
| 984264 | COG1027 | K01679 | map00020 | cellular organisms |
| 984807 | COG0012 | K06942 | NA | Clostridium thermocellum |
| 984813 | COG0042 | K05544 | NA | Schizosaccharomyces |
| 985573 | NA | NA | NA | — |
| 985686 | COG0593 | K02313 | NA | Clostridium |
| 986573 | NA | NA | NA | — |
| 986887 | NA | NA | NA | — |
| 987369 | COG2357 | K00951 | map00230 | Clostridiales |
| 987573 | COG1396 | K00517 | NA | Clostridiales |
| 987749 | NA | NA | NA | — |
| 987869 | COG0652 | K01802 | NA | Eukaryota |
| 988131 | NA | NA | NA | — |
| 988239 | NA | NA | NA | — |
| 988624 | COG1190 | K04567 | map00300 | Bacteroides capillosus |
| 988901 | NA | NA | NA | — |
| 988992 | NA | NA | NA | Bacteroides capillosus |
| 990803 | NA | NA | NA | — |
| 991371 | NA | NA | NA | — |
| 992093 | NA | NA | NA | — |
| 993022 | NA | NA | NA | Lentisphaera araneosa |
| 993023 | NA | NA | NA | root |
| 993676 | COG0357 | K03501 | NA | Firmicutes |
| 994346 | COG0515 | K03083 | map04012 | Eukaryota |
| 994514 | COG1293 | NA | NA | Clostridium thermocellum |
| 994675 | COG1164 | K08602 | NA | Thermoanaerobacter |
| 994879 | NA | NA | NA | — |
| 995248 | COG0187 | K02470 | NA | Carboxydothermus hydrogenoformans |
| 995319 | COG1940 | K00845 | map00010 | Bacteria |
| 995630 | NOG23158 | NA | NA | Ruminococcus torques |
| 997271 | NA | NA | NA | — |
| 998136 | NOG16854 | NA | NA | Clostridium bolteae |
| 999609 | COG0258 | K02335 | map00230 | Ruminococcus gnavus |
| 1000035 | COG0612 | K01422 | NA | Clostridium |
| 1000135 | COG2147 | K02885 | NA | Insecta |
| 1000173 | COG2088 | K06412 | NA | Bacteria |
| 1000414 | COG0543 | K00528 | NA | Eubacterium dolichum |
| 1000839 | COG1175 | K02025 | NA | Bacteria |
| 1000930 | NA | NA | NA | — |
| 1003010 | COG2273 | K01199 | map00500 | Clostridium |
| 1003309 | NA | K06147 | NA | Faecalibacterium prausnitzii |
| 1003735 | COG1838 | K01676 | map00020 | Faecalibacterium prausnitzii |
| 1006216 | COG0863 | K00590 | NA | Geobacillus |
| 1007586 | COG1211 | K00991 | map00100 | Faecalibacterium prausnitzii |
| 1007857 | COG1288 | NA | NA | Clostridium |
| 1016289 | COG0085 | K03043 | map03020 | Clostridiales |
| 1020717 | NOG11062 | NA | NA | Roseburia inulinivorans |
| 1022607 | NOG09722 | NA | NA | Clostridium |
| 1025105 | COG3481 | K03698 | NA | Clostridium |
| 1025287 | COG0855 | K00937 | map00190 | — |
| 1026485 | COG4585 | K07778 | map02020 | Clostridium |
| 1027655 | COG0766 | K00790 | map00530 | Clostridium |
| 1029915 | COG0366 | K01187 | map00052 | Clostridium asparagiforme |
| 1031162 | COG0473 | K00031 | map00020 | Clostridium asparagiforme |
| 1031793 | COG0642 | K02489 | map02020 | Clostridiales |
| 1032957 | COG2337 | K07171 | NA | Faecalibacterium prausnitzii |
| 1036305 | COG0444 | K02031 | NA | Lysinibacillus sphaericus |
| 1038549 | COG0642 | K07636 | map02020 | Faecalibacterium prausnitzii |
| 1038782 | COG0210 | K03657 | map03420 | Faecalibacterium prausnitzii |
| 1039604 | NA | NA | NA | Faecalibacterium prausnitzii |
| 1039739 | NA | NA | NA | Faecalibacterium prausnitzii |
| 1044361 | COG2309 | K01255 | map00480 | Faecalibacterium prausnitzii |
| 1074801 | COG0187 | K02470 | NA | Clostridium bolteae |
| 1078399 | COG1961 | K06400 | NA | Syntrophomonas wolfei |
| 1078918 | COG0488 | K06158 | NA | Firmicutes |
| 1079333 | COG1744 | K02058 | NA | — |
| 1083008 | NA | NA | NA | — |
| 1083232 | COG2316 | K06951 | NA | Ruminococcus lactaris |
| 1087413 | COG4868 | NA | NA | Roseburia inulinivorans |
| 1090984 | NA | NA | NA | Eubacterium siraeum |
| 1091819 | NA | NA | NA | Clostridium hylemonae |
| 1093507 | COG1033 | K07003 | NA | Clostridiales |
| 1093508 | NA | NA | NA | Eubacterium siraeum |
| 1095878 | NA | NA | NA | Eubacterium siraeum |
| 1096559 | COG1136 | K02003 | NA | Eubacterium siraeum |
| 1098186 | NA | NA | NA | — |
| 1098187 | NA | NA | NA | — |
| 1098885 | COG2344 | K01926 | NA | Eubacterium siraeum |
| 1099121 | COG0488 | K06158 | NA | Bacteroides capillosus |
| 1099229 | NA | NA | NA | Butyrivibrio |
| 1099254 | NA | NA | NA | — |
| 1099472 | NA | NA | NA | — |
| 1100532 | COG3291 | K01448 | map00550 | Trichomonas vaginalis |
| 1101927 | COG1570 | K03601 | map03430 | Bacteroides capillosus |
| 1102135 | NA | NA | NA | Eubacterium siraeum |
| 1102690 | COG0596 | K01512 | map00010 | Eubacterium siraeum |
| 1104248 | COG0331 | K00645 | map00061 | Bacteria |
| 1104317 | COG3344 | K00986 | NA | Clostridium asparagiforme |
| 1105204 | NA | NA | NA | — |
| 1105612 | NA | NA | NA | Eubacterium siraeum |
| 1105670 | NA | NA | NA | Clostridium thermocellum |
| 1106098 | NOG09002 | NA | NA | Desulfitobacterium hafniense |
| 1106099 | NA | NA | NA | Desulfitobacterium hafniense |
| 1106100 | COG1961 | NA | NA | Bacteria |
| 1106101 | COG1396 | NA | NA | Clostridiales |
| 1106350 | NA | NA | NA | Eubacterium siraeum |
| 1106429 | NA | NA | NA | — |
| 1108588 | NOG04984 | K05970 | NA | Eubacterium siraeum |
| 1131337 | NA | NA | NA | — |
| 1146993 | COG0210 | K03657 | map03420 | Bacteroides capillosus |
| 1148840 | NA | NA | NA | — |
| 1153439 | NA | NA | NA | Ruminococcus lactaris |
| 1184191 | NA | K10188 | NA | — |
| 1184764 | NA | NA | NA | Clostridium |
| 1184821 | NA | NA | NA | — |
| 1184822 | NA | NA | NA | — |
| 1187141 | COG0256 | K02881 | NA | Clostridiales |
| 1189828 | COG0514 | K03654 | NA | Clostridiales |
| 1190815 | NA | NA | NA | — |
| 1196411 | COG4660 | K03613 | NA | Clostridium bolteae |
| 1233375 | COG1117 | K02036 | map02010 | Eubacterium siraeum |
| 1235445 | COG3533 | K09955 | NA | Eubacterium siraeum |
| 1235565 | KOG4726 | K03613 | NA | Faecalibacterium prausnitzii |
| 1235844 | COG0366 | K01200 | NA | Eubacterium siraeum |
| 1236828 | COG4146 | K03307 | NA | Bacteroides |
| 1237309 | COG0758 | K04096 | NA | Eubacterium siraeum |
| 1237851 | COG3468 | NA | NA | Eubacterium siraeum |
| 1237977 | COG0703 | K00891 | map00400 | Eubacterium siraeum |
| 1238964 | COG0205 | K00850 | map00010 | Eubacterium siraeum |
| 1239044 | COG4485 | NA | NA | Eubacterium siraeum |
| 1239386 | COG2730 | K01179 | map00500 | Eubacterium siraeum |
| 1239545 | NOG21901 | NA | NA | Faecalibacterium prausnitzii |
| 1239552 | COG1181 | K01921 | map00473 | Eubacterium siraeum |
| 1240796 | COG0210 | K01529 | map00790 | Eubacterium siraeum |
| 1241551 | NA | NA | NA | Eubacterium siraeum |
| 1243154 | NA | NA | NA | — |
| 1243627 | NA | NA | NA | Faecalibacterium prausnitzii |
| 1244765 | COG0561 | K07024 | NA | Eubacterium siraeum |
| 1247386 | COG2145 | K00878 | map00730 | Eubacterium siraeum |
| 1247391 | NA | NA | NA | — |
| 1247646 | COG0341 | K03074 | NA | Eubacterium siraeum |
| 1247895 | COG4912 | NA | NA | Eubacterium siraeum |
| 1248773 | NA | NA | NA | — |
| 1248778 | NA | NA | NA | Eubacterium biforme |
| 1249002 | NA | NA | NA | Eubacterium siraeum |
| 1249004 | COG0840 | K03406 | NA | Bacteria |
| 1249264 | NA | NA | NA | Faecalibacterium prausnitzii |
| 1249351 | COG4422 | NA | NA | Eubacterium siraeum |
| 1249680 | COG3757 | K01448 | map00550 | Eubacterium siraeum |
| 1258139 | NA | NA | NA | Bacteria |
| 1261624 | NA | NA | NA | — |
| 1262548 | NA | NA | NA | Bacteria |
| 1262550 | COG1309 | NA | NA | Bifidobacterium dentium |
| 1262551 | COG1063 | K00060 | map00051 | Eubacterium biforme |
| 1262955 | COG2003 | K03630 | NA | Bacteroides pectinophilus |
| 1263369 | NA | NA | NA | Eubacterium siraeum |
| 1263370 | NA | NA | NA | — |
| 1263621 | NA | NA | NA | — |
| 1263641 | COG1653 | K10117 | NA | Eubacterium hallii |
| 1264797 | COG5505 | NA | NA | Alkaliphilus oremlandii |
| 1265580 | NA | NA | NA | — |
| 1265583 | COG1132 | K06147 | map02010 | Eubacterium siraeum |
| 1265698 | NA | NA | NA | root |
| 1266195 | NA | NA | NA | Clostridiales |
| 1266545 | COG0732 | K01154 | NA | Bacteroides plebeius |
| 1266570 | NA | NA | NA | — |
| 1270329 | NA | NA | NA | — |
| 1270827 | COG0353 | K06187 | NA | Roseburia inulinivorans |
| 1270940 | NA | NA | NA | Bacteroides pectinophilus |
| 1271198 | NOG13858 | NA | NA | Bacteria |
| 1271641 | COG0166 | K01810 | map00010 | Ruminococcus lactaris |
| 1273216 | COG1887 | K00703 | map00500 | Clostridium phytofermentans |
| 1273610 | COG5295 | NA | NA | — |
| 1281776 | COG0458 | K01955 | map00240 | Bacteria |
| 1299082 | COG0706 | K03217 | NA | Bordetella |
| 1299347 | COG1185 | K00962 | map00230 | Burkholderia |
| 1301623 | NA | NA | NA | — |
| 1302090 | COG0842 | K01992 | NA | Clostridium kluyveri |
| 1303020 | COG1882 | K00656 | map00620 | Bacteroides |
| 1307816 | NA | NA | NA | Eubacterium siraeum |
| 1316237 | NA | NA | NA | Eubacterium biforme |
| 1320576 | NA | NA | NA | — |
| 1385412 | COG0546 | K01091 | map00630 | Eubacterium hallii |
| 1392436 | COG1185 | K00962 | map00230 | Bacteroides pectinophilus |
| 1397430 | COG0591 | K03307 | NA | Anaerofustis stercorihominis |
| 1404443 | COG2205 | K07646 | map02020 | Eubacterium hallii |
| 1420469 | COG1087 | K01784 | map00052 | Clostridium |
| 1429341 | COG2211 | K03292 | NA | Clostridiales |
| 1446590 | COG0129 | K01687 | map00290 | Bacteria |
| 1447147 | NA | K03737 | map00620 | Akkermansia muciniphila |
| 1447446 | COG0716 | K00536 | map00910 | Eubacterium siraeum |
| 1447685 | COG0144 | K03500 | NA | Akkermansia muciniphila |
| 1449123 | COG0195 | K02600 | NA | Akkermansia muciniphila |
| 1449526 | COG0438 | K08256 | NA | Akkermansia muciniphila |
| 1449696 | COG3604 | K02584 | NA | Bacteria |
| 1450020 | COG1586 | K01611 | map00220 | Eubacterium siraeum |
| 1450465 | NA | NA | NA | Eubacterium siraeum |
| 1451813 | COG2060 | K01546 | map02020 | Akkermansia muciniphila |
| 1451855 | COG0050 | K02358 | NA | Dictyoglomus thermophilum |
| 1453142 | COG0541 | K03106 | NA | Clostridiales |
| 1454732 | COG2165 | NA | NA | — |
| 1454745 | COG0238 | K02963 | NA | Eubacterium siraeum |
| 1455568 | COG0071 | K04080 | NA | Eubacterium siraeum |
| 1456520 | COG0610 | K01153 | NA | Bacteria |
| 1457133 | COG1385 | K09761 | NA | Eubacterium siraeum |
| 1457257 | NA | NA | NA | Eubacterium siraeum |
| 1457537 | NA | NA | NA | Eubacterium siraeum |
| 1457744 | NA | NA | NA | Eubacterium siraeum |
| 1457750 | COG0037 | K04075 | NA | Firmicutes |
| 1458327 | NOG18209 | NA | NA | Bacteria |
| 1458618 | COG0846 | K01463 | NA | Ruminococcus lactaris |
| 1459197 | NOG15851 | K03827 | NA | Eubacterium siraeum |
| 1459332 | NA | NA | NA | Eubacterium siraeum |
| 1459698 | COG0072 | K01890 | map00400 | Clostridiales |
| 1460511 | COG1092 | K06969 | NA | Eubacterium siraeum |
| 1460862 | NA | NA | NA | Eubacterium siraeum |
| 1461002 | COG4509 | K08600 | NA | Eubacterium siraeum |
| 1461903 | COG1883 | K01605 | map00640 | Eubacterium siraeum |
| 1461916 | NA | NA | NA | — |
| 1462425 | COG3583 | NA | NA | Eubacterium siraeum |
| 1462519 | COG0613 | K07053 | NA | Eubacterium siraeum |
| 1462920 | COG0172 | K01875 | map00260 | Eubacterium siraeum |
| 1462921 | COG1475 | K03497 | NA | Eubacterium siraeum |
| 1463003 | NA | NA | NA | Eubacterium siraeum |
| 1463106 | NA | NA | NA | Eubacterium siraeum |
| 1463747 | NA | NA | NA | Desulfitobacterium hafniense |
| 1463748 | NA | NA | NA | Bacteroides pectinophilus |
| 1464344 | COG4295 | NA | NA | Eubacterium siraeum |
| 1464542 | NA | NA | NA | — |
| 1465173 | COG0556 | K03702 | NA | Firmicutes |
| 1465346 | NA | NA | NA | — |
| 1465360 | COG1670 | K00676 | NA | Eubacterium siraeum |
| 1465670 | NA | NA | NA | — |
| 1465954 | NA | NA | NA | — |
| 1466726 | COG0050 | K02358 | NA | cellular organisms |
| 1468715 | NA | NA | NA | — |
| 1469426 | COG0087 | K02906 | NA | Synechococcus |
| 1469532 | NA | NA | NA | Bacteroides capillosus |
| 1470497 | COG0216 | K02835 | NA | Trichodesmium erythraeum |
| 1472235 | COG0711 | K02109 | map00190 | cellular organisms |
| 1473577 | COG3210 | NA | NA | Clostridium cellulolyticum |
| 1479330 | COG3299 | NA | NA | Enterobacteriaceae |
| 1479339 | NA | NA | NA | — |
| 1479340 | NA | NA | NA | — |
| 1485035 | COG3546 | K06334 | NA | Clostridium |
| 1485901 | COG0789 | NA | NA | Blautia hydrogenotrophica |
| 1493861 | NA | NA | NA | Clostridium |
| 1504786 | COG0480 | K02355 | NA | Bacteria |
| 1527181 | COG1475 | K03497 | NA | Clostridium |
| 1552172 | COG2262 | K03665 | NA | Faecalibacterium prausnitzii |
| 1554681 | NA | K06940 | NA | Faecalibacterium prausnitzii |
| 1554904 | COG0215 | K01883 | map00272 | Faecalibacterium prausnitzii |
| 1555087 | NA | K02027 | NA | Clostridium ramosum |
| 1555245 | COG1511 | K01421 | NA | Faecalibacterium prausnitzii |
| 1555832 | COG0492 | K00384 | map00240 | Faecalibacterium prausnitzii |
| 1556202 | NOG07807 | NA | NA | Faecalibacterium prausnitzii |
| 1556370 | COG2207 | K02099 | NA | Faecalibacterium prausnitzii |
| 1556372 | COG1126 | K10041 | map02010 | Clostridiales |
| 1556549 | COG0331 | K00645 | map00061 | Faecalibacterium prausnitzii |
| 1556775 | COG0749 | K02335 | map00230 | Faecalibacterium prausnitzii |
| 1556932 | NA | K03593 | NA | Clostridium leptum |
| 1558245 | COG0739 | NA | NA | Faecalibacterium prausnitzii |
| 1558722 | COG1104 | K04487 | map00730 | Faecalibacterium prausnitzii |
| 1559333 | NA | NA | NA | — |
| 1559501 | COG1196 | K03529 | NA | Faecalibacterium prausnitzii |
| 1560267 | NA | K02547 | NA | Clostridiales |
| 1561054 | COG0553 | K08282 | NA | Faecalibacterium prausnitzii |
| 1564417 | COG2017 | NA | NA | Faecalibacterium prausnitzii |
| 1565761 | COG0392 | K07027 | NA | Faecalibacterium prausnitzii |
| 1566124 | NA | NA | NA | Faecalibacterium prausnitzii |
| 1566504 | COG0428 | K07238 | NA | Faecalibacterium prausnitzii |
| 1566622 | NA | NA | NA | Faecalibacterium prausnitzii |
| 1567335 | COG0577 | K02004 | NA | Faecalibacterium prausnitzii |
| 1567939 | COG0449 | K00820 | map00251 | Faecalibacterium prausnitzii |
| 1570930 | NA | NA | NA | — |
| 1571266 | COG2082 | K06042 | map00860 | Faecalibacterium prausnitzii |
| 1572246 | COG1192 | K03496 | NA | Clostridium bolteae |
| 1572291 | NA | NA | NA | Faecalibacterium prausnitzii |
| 1575899 | NA | NA | NA | — |
| 1576240 | COG0653 | K03070 | NA | Faecalibacterium prausnitzii |
| 1586727 | COG1964 | K06937 | NA | Bacteria |
| 1589094 | NOG06133 | NA | NA | Clostridiales |
| 1592065 | COG1247 | NA | NA | Finegoldia magna |
| 1593101 | COG0372 | K01659 | map00640 | Faecalibacterium prausnitzii |
| 1593169 | COG1136 | K05685 | NA | Faecalibacterium prausnitzii |
| 1596989 | COG0703 | K00014 | map00400 | Faecalibacterium prausnitzii |
| 1597072 | COG1518 | NA | NA | Firmicutes |
| 1598739 | COG3857 | K01144 | NA | Faecalibacterium prausnitzii |
| 1601619 | COG0697 | K03298 | NA | Faecalibacterium prausnitzii |
| 1602210 | NA | NA | NA | Faecalibacterium prausnitzii |
| 1602941 | COG1132 | K06147 | NA | Bacteria |
| 1603763 | COG3394 | K03478 | NA | Synechococcus |
| 1610182 | NA | K02484 | NA | Bacteroides |
| 1612462 | NOG34819 | NA | NA | Bacteroides intestinalis |
| 1613471 | NA | NA | NA | — |
| 1613590 | NA | NA | NA | — |
| 1614067 | COG1175 | K10118 | NA | Streptococcus infantarius |
| 1615301 | COG0050 | K02358 | NA | Bacteria |
| 1617244 | NA | K03046 | map03020 | Clostridia |
| 1619505 | NA | K03324 | NA | Clostridiales |
| 1621790 | NA | K01507 | map00190 | Clostridium |
| 1624391 | NA | K09762 | NA | Clostridium asparagiforme |
| 1625788 | NA | K00688 | map00500 | Clostridium bolteae |
| 1626208 | COG0389 | K03502 | NA | Bacteria |
| 1626640 | COG1217 | K06207 | NA | Clostridiales |
| 1627407 | NA | NA | NA | Clostridium |
| 1627820 | COG1132 | K06147 | NA | Catenibacterium mitsuokai |
| 1628630 | NA | K02123 | map00190 | — |
| 1629280 | NA | K00088 | map00230 | Clostridium |
| 1629624 | NA | NA | NA | — |
| 1635112 | NA | NA | NA | — |
| 1639469 | COG0582 | K04763 | NA | Moorella thermoacetica |
| 1667205 | NA | NA | NA | — |
| 1675394 | NA | NA | NA | cellular organisms |
| 1680948 | COG0523 | K02234 | NA | Clostridium |
| 1683707 | NA | NA | NA | — |
| 1684336 | NA | NA | NA | — |
| 1688733 | COG0059 | K00053 | map00290 | Eubacterium siraeum |
| 1692792 | NA | NA | NA | Bacteroides pectinophilus |
| 1704961 | NA | NA | NA | — |
| 1706327 | NA | NA | NA | — |
| 1711948 | COG0556 | K03702 | NA | Bacteria |
| 1717525 | COG4962 | K02283 | NA | — |
| 1719136 | COG1894 | K00335 | map00130 | Clostridium scindens |
| 1727799 | COG0542 | K03697 | NA | Faecalibacterium prausnitzii |
| 1733925 | COG0264 | K02357 | NA | Bacteroides capillosus |
| 1736158 | COG4747 | NA | NA | Desulfatibacillum alkenivorans |
| 1749372 | COG0601 | K02033 | NA | Clostridium phytofermentans |
| 1751361 | COG0031 | K01738 | map00272 | Clostridium |
| 1751890 | NA | NA | NA | — |
| 1753439 | COG0274 | K01619 | map00030 | Clostridium |
| 1755262 | COG0494 | K01529 | map00790 | Nostocaceae |
| 1760276 | NA | NA | NA | — |
| 1762115 | COG0758 | K04096 | NA | Clostridiaceae |
| 1762189 | COG3279 | K02477 | NA | — |
| 1767918 | NA | K02337 | map03030 | Cyanobacteria |
| 1767998 | NA | NA | NA | — |
| 1768609 | COG1132 | K06147 | NA | Bacteroides capillosus |
| 1776073 | NA | NA | NA | Firmicutes |
| 1781621 | NA | NA | NA | — |
| 1785115 | NA | NA | NA | Faecalibacterium prausnitzii |
| 1787956 | COG1939 | K11145 | NA | Clostridium |
| 1789280 | NA | NA | NA | — |
| 1796613 | COG0303 | K03750 | NA | Faecalibacterium prausnitzii |
| 1807503 | COG1087 | K01784 | map00052 | Faecalibacterium prausnitzii |
| 1816344 | NA | NA | NA | — |
| 1818912 | NA | NA | NA | Faecalibacterium prausnitzii |
| 1838715 | NA | NA | NA | — |
| 1843220 | NA | NA | NA | — |
| 1855833 | COG4496 | NA | NA | Clostridiales |
| 1863475 | COG0563 | K00939 | map00230 | Clostridium bolteae |
| 1882631 | COG0370 | K04759 | NA | Eubacterium siraeum |
| 1883327 | COG0463 | K00721 | map00510 | Bacteroides pectinophilus |
| 1883355 | COG0343 | K00773 | NA | Clostridiales |
| 1883368 | NA | NA | NA | Eubacterium hallii |
| 1883543 | COG0052 | K02967 | NA | Eubacterium siraeum |
| 1884025 | COG0845 | K02005 | NA | — |
| 1884423 | COG1219 | K03544 | NA | Eubacterium siraeum |
| 1885117 | COG1516 | K02422 | NA | Clostridium phytofermentans |
| 1890560 | NA | NA | NA | Clostridium |
| 1890808 | NA | NA | NA | Eubacterium ventriosum |
| 1891748 | COG0389 | K02346 | NA | Clostridiales |
| 1892260 | COG0546 | K01091 | map00630 | Clostridium bolteae |
| 1894475 | COG1190 | K04567 | map00300 | Clostridiales |
| 1898063 | NA | NA | NA | Syntrophomonas wolfei |
| 1902038 | COG2207 | K07471 | NA | Clostridium botulinum |
| 1902353 | COG0165 | K01755 | map00220 | Eubacterium siraeum |
| 1907099 | COG1299 | K02768 | map02060 | Firmicutes |
| 1910670 | NOG35098 | NA | NA | Bacteroides cellulosilyticus |
| 1917517 | COG1226 | K04878 | NA | Bacteroides |
| 1919046 | NA | NA | NA | — |
| 1919943 | NOG08575 | K06012 | NA | Clostridia |
| 1921986 | NA | NA | NA | Roseburia inulinivorans |
| 1926277 | COG4932 | NA | NA | Ruminococcus torques |
| 1926370 | COG0500 | K00551 | map00260 | Clostridiales |
| 1928977 | NA | NA | NA | Gammaproteobacteria |
| 1953014 | COG0582 | NA | NA | Anaerotruncus colihominis |
| 1961020 | NA | NA | NA | — |
| 1970307 | COG1066 | K04485 | NA | Bacteroides pectinophilus |
| 1970479 | NA | NA | NA | Bacteroides pectinophilus |
| 1970662 | COG0760 | K07533 | NA | Bacteroides pectinophilus |
| 1970785 | COG0463 | K00721 | map00510 | Syntrophomonas wolfei |
| 1970913 | COG0167 | K00226 | map00240 | Bacteria |
| 1971006 | NA | NA | NA | — |
| 1971147 | NA | NA | NA | Eubacterium siraeum |
| 1971187 | COG1561 | NA | NA | Bacteroides pectinophilus |
| 1971528 | COG4732 | K02006 | NA | Faecalibacterium prausnitzii |
| 1971589 | NA | NA | NA | — |
| 1971596 | COG0712 | K02113 | map00190 | Bacteria |
| 1971819 | COG4716 | K10254 | NA | Roseburia inulinivorans |
| 1972495 | COG3238 | K09936 | NA | Bacteroides pectinophilus |
| 1973327 | COG0557 | K01147 | NA | Bacteria |
| 1974286 | COG0131 | K01693 | map00340 | Roseburia inulinivorans |
| 1974432 | COG0250 | K02601 | NA | Clostridiales |
| 1974667 | NA | NA | NA | — |
| 1975680 | COG2081 | K07007 | NA | Bacteroides pectinophilus |
| 1976403 | COG0621 | K06168 | NA | Bacteria |
| 1976405 | COG0014 | K00147 | map00220 | Ruminococcus lactaris |
| 1978607 | COG0494 | K01554 | NA | Clostridiales |
| 1978613 | NA | NA | NA | Clostridium |
| 1978780 | COG0352 | NA | NA | Clostridium bartlettii |
| 1978829 | COG1846 | K03712 | NA | Bacteroides pectinophilus |
| 1980841 | COG0503 | K00759 | map00230 | Bacteroides pectinophilus |
| 1982069 | NA | NA | NA | Roseburia inulinivorans |
| 1982882 | COG0679 | K07088 | NA | Bacteroides pectinophilus |
| 1984223 | COG3291 | K01448 | map00550 | Eubacterium siraeum |
| 1984812 | NOG21910 | NA | NA | — |
| 1985066 | COG0784 | K03415 | NA | Bacteroides pectinophilus |
| 1990443 | COG3274 | NA | NA | Bacteria |
| 1991186 | COG0071 | NA | NA | Bacteroides uniformis |
| 1994013 | NA | NA | NA | — |
| 1995770 | NA | NA | NA | — |
| 2009592 | NA | NA | NA | Bacteroides uniformis |
| 2021040 | COG4166 | K02035 | NA | Clostridium butyricum |
| 2023697 | COG2848 | K09157 | NA | Clostridium leptum |
| 2031716 | COG0059 | K00053 | map00290 | Blautia hydrogenotrophica |
| 2046128 | COG0465 | K03798 | NA | Faecalibacterium prausnitzii |
| 2048454 | COG0534 | K03327 | NA | Blautia hydrogenotrophica |
| 2052703 | COG0601 | K02033 | NA | Clostridium bolteae |
| 2058943 | COG0466 | K01338 | NA | Firmicutes |
| 2074719 | COG0275 | K03438 | NA | Flavobacteria |
| 2079028 | COG0566 | K00599 | map00150 | Faecalibacterium prausnitzii |
| 2105782 | NOG24756 | NA | NA | Bacteroides |
| 2108301 | COG1961 | K06400 | NA | Heliobacterium modesticaldum |
| 2113638 | NA | NA | NA | — |
| 2113962 | NOG16497 | NA | NA | Bacteria |
| 2114333 | NA | NA | NA | — |
| 2114464 | COG1386 | K06024 | NA | Anaerostipes caccae |
| 2116380 | COG5368 | NA | NA | Fervidobacterium nodosum |
| 2116496 | NA | NA | NA | — |
| 2116828 | COG0221 | K01507 | map00190 | Clostridiales |
| 2117205 | COG0564 | K06180 | NA | Alistipes putredinis |
| 2125968 | NA | NA | NA | — |
| 2129464 | NA | NA | NA | — |
| 2129825 | NA | NA | NA | — |
| 2130465 | COG1136 | K02003 | NA | Clostridium |
| 2140646 | NA | NA | NA | — |
| 2149404 | COG0433 | K06915 | NA | Erwinia tasmaniensis |
| 2151597 | NA | NA | NA | Bacteroides pectinophilus |
| 2170295 | NA | NA | NA | — |
| 2175616 | COG4422 | NA | NA | Heliobacterium modesticaldum |
| 2184781 | COG0086 | K03046 | map03020 | Bacteroides pectinophilus |
| 2185209 | NA | NA | NA | — |
| 2196550 | NA | NA | NA | — |
| 2232932 | COG4283 | NA | NA | Clostridium nexile |
| 2236205 | NA | NA | NA | Clostridium |
| 2237516 | NOG16673 | K01238 | map00530 | Planctomycetaceae |
| 2237522 | NA | NA | NA | Parabacteroides distasonis |
| 2257924 | COG0745 | K07657 | NA | Clostridiales |
| 2258899 | COG1670 | K00676 | NA | Coprococcus comes |
| 2267893 | NA | NA | NA | — |
| 2270184 | COG2003 | K03630 | NA | Clostridia |
| 2274518 | NA | NA | NA | Eubacterium siraeum |
| 2275783 | NOG21673 | NA | NA | Clostridium phytofermentans |
| 2275807 | COG0197 | K02878 | NA | Synechococcus |
| 2277019 | NA | NA | NA | — |
| 2278234 | COG1702 | K06217 | NA | Faecalibacterium prausnitzii |
| 2278691 | COG2873 | K01740 | map00271 | Clostridiales |
| 2279669 | COG3279 | NA | NA | Faecalibacterium prausnitzii |
| 2282098 | COG0199 | K02954 | NA | Gloeobacter violaceus |
| 2283397 | COG4268 | NA | NA | cellular organisms |
| 2283545 | COG2217 | K01533 | NA | Ruminococcus obeum |
| 2283831 | COG4111 | K01529 | map00790 | Bacteroides pectinophilus |
| 2284460 | COG1940 | K02565 | NA | Coprococcus comes |
| 2285666 | NA | NA | NA | Coprococcus eutactus |
| 2285667 | NA | NA | NA | Coprococcus eutactus |
| 2286016 | COG0210 | K03657 | map03420 | Bacteria |
| 2286744 | NA | K03612 | NA | Clostridiales |
| 2287009 | COG0317 | K00951 | map00230 | Clostridium phytofermentans |
| 2287268 | NA | NA | NA | Clostridium |
| 2287915 | COG1132 | K06147 | NA | Clostridiales |
| 2288051 | COG0495 | K01869 | map00290 | Clostridium |
| 2288429 | NA | NA | NA | Clostridium |
| 2288670 | COG0371 | K02102 | NA | Clostridium |
| 2289046 | COG3335 | K07494 | NA | Ruminococcus gnavus |
| 2289205 | NA | NA | NA | Roseburia inulinivorans |
| 2289743 | COG1080 | K08483 | map02060 | Lachnospiraceae |
| 2289978 | NA | NA | NA | Dorea formicigenerans |
| 2291479 | COG1838 | K03780 | map00630 | Bacteroides pectinophilus |
| 2295529 | COG1207 | K07141 | NA | Clostridium |
| 2295537 | COG0153 | K00849 | map00052 | Clostridium |
| 2295746 | COG0168 | K03498 | NA | Clostridiales |
| 2295832 | COG1082 | NA | NA | Faecalibacterium prausnitzii |
| 2297335 | COG1131 | K01990 | NA | Clostridiales |
| 2298724 | COG0275 | K03438 | NA | Clostridiales |
| 2299043 | COG4938 | NA | NA | Bacteria |
| 2299726 | NOG34795 | NA | NA | Coprococcus comes |
| 2345433 | NA | NA | NA | — |
| 2345435 | COG0494 | K03574 | NA | — |
| 2345771 | COG1592 | K00532 | map00630 | Clostridiales |
| 2345904 | COG1132 | K06147 | NA | Clostridiales |
| 2345927 | COG0421 | K00797 | map00220 | Catenibacterium mitsuokai |
| 2346527 | NA | K03217 | NA | — |
| 2347115 | COG0733 | K03308 | NA | Eubacterium ventriosum |
| 2347973 | NA | NA | NA | — |
| 2348195 | COG2242 | K02191 | map00860 | — |
| 2348333 | COG4856 | NA | NA | Clostridiales |
| 2348835 | COG0860 | K01448 | map00550 | Ruminococcus lactaris |
| 2349040 | COG1613 | K02048 | NA | Bacteria |
| 2349417 | COG0281 | K00027 | map00620 | — |
| 2349561 | NA | NA | NA | — |
| 2350068 | COG0538 | K00031 | map00020 | — |
| 2350114 | NA | NA | NA | Coprococcus eutactus |
| 2350780 | COG1477 | K03734 | NA | Eubacterium hallii |
| 2351118 | NOG25815 | K01187 | map00052 | Bacteria |
| 2351464 | COG3887 | NA | NA | Ruminococcus obeum |
| 2351562 | NA | NA | NA | — |
| 2352545 | COG0351 | K00877 | map00730 | Clostridiales |
| 2352662 | NA | K07033 | NA | Lachnospiraceae |
| 2352693 | NA | NA | NA | — |
| 2353128 | COG3633 | K07862 | NA | Eubacterium hallii |
| 2353441 | NA | NA | NA | Clostridiales |
| 2353442 | NA | NA | NA | Clostridium cellulolyticum |
| 2353729 | COG1302 | NA | NA | Clostridium nexile |
| 2354373 | COG0722 | K01626 | map00400 | Ruminococcus obeum |
| 2354374 | NA | NA | NA | — |
| 2354720 | COG0569 | K03499 | NA | — |
| 2354764 | COG1132 | K06147 | NA | Bacteroides pectinophilus |
| 2354794 | COG0474 | K01529 | map00790 | Blautia hydrogenotrophica |
| 2355321 | NA | NA | NA | Roseburia inulinivorans |
| 2356009 | COG1951 | K03779 | map00630 | Bacteroides pectinophilus |
| 2356338 | COG0581 | K02038 | NA | Clostridium hylemonae |
| 2357787 | COG5001 | K02488 | NA | — |
| 2358117 | COG1982 | K01582 | map00220 | Catenibacterium mitsuokai |
| 2358284 | COG2239 | K06213 | NA | Dorea formicigenerans |
| 2358336 | NA | NA | NA | — |
| 2359154 | NA | NA | NA | — |
| 2359806 | NOG26452 | NA | NA | — |
| 2360397 | COG0368 | K02233 | map00860 | Roseburia inulinivorans |
| 2360552 | COG0165 | K01755 | map00220 | Clostridiales |
| 2360764 | COG0745 | K02483 | NA | Bacteroides pectinophilus |
| 2360905 | NA | NA | NA | — |
| 2361869 | COG1053 | K00394 | map00450 | Clostridiales |
| 2363295 | NA | NA | NA | Roseburia inulinivorans |
| 2363624 | COG0038 | K03281 | NA | Ruminococcus obeum |
| 2363649 | NA | NA | NA | Desulfitobacterium hafniense |
| 2364118 | NA | NA | NA | Eubacterium hallii |
| 2364714 | NOG08812 | NA | NA | — |
| 2368698 | COG0443 | K04043 | NA | — |
| 2371135 | COG4926 | NA | NA | Clostridium acetobutylicum |
| 2371698 | NA | NA | NA | — |
| 2373903 | NA | NA | NA | — |
| 2377078 | NA | NA | NA | Clostridium bolteae |
| 2388534 | NA | NA | NA | Bacteroides |
| 2390702 | NA | K03553 | NA | Bacteroides |
| 2391272 | COG0204 | K00655 | map00561 | Faecalibacterium prausnitzii |
| 2416715 | COG0086 | K03046 | map03020 | Bacteria |
| 2417405 | COG3250 | K01238 | map00530 | Bacteroides |
| 2417656 | COG0534 | K03327 | NA | Bacteroides cellulosilyticus |
| 2419417 | NA | NA | NA | — |
| 2419991 | COG0511 | K01960 | map00020 | Bacteroides |
| 2422713 | COG0514 | K03654 | NA | Bacteroides |
| 2429063 | COG1122 | K02006 | NA | Bacteroides capillosus |
| 2437460 | COG0249 | K03555 | NA | Bacteroides |
| 2440502 | NOG34575 | NA | NA | Bacteroides |
| 2441401 | NOG25022 | NA | NA | Bacteroides |
| 2448219 | COG0140 | K01496 | map00340 | Bacteroidales |
| 2452621 | COG0534 | K03327 | NA | Eubacterium siraeum |
| 2453007 | COG2337 | K07171 | NA | Eubacterium siraeum |
| 2453405 | COG0456 | K03826 | NA | Eubacterium siraeum |
| 2454577 | COG0304 | K09458 | map00061 | Eubacterium siraeum |
| 2454584 | COG1228 | K01468 | map00340 | Eubacterium siraeum |
| 2454587 | COG0219 | K03216 | NA | Eubacterium siraeum |
| 2454614 | NA | NA | NA | Eubacterium siraeum |
| 2454620 | NA | K02488 | NA | Eubacterium siraeum |
| 2455947 | COG2267 | K01048 | map00564 | Eubacterium siraeum |
| 2455952 | COG0249 | K03555 | NA | Eubacterium siraeum |
| 2456617 | COG1377 | K04061 | NA | Eubacterium siraeum |
| 2456618 | NA | NA | NA | Eubacterium siraeum |
| 2456780 | COG1766 | K02409 | NA | Eubacterium siraeum |
| 2456782 | COG1157 | K02412 | map02040 | Eubacterium siraeum |
| 2456789 | COG1776 | K02417 | NA | Eubacterium siraeum |
| 2456792 | COG1338 | K02419 | NA | Eubacterium siraeum |
| 2456795 | COG1377 | K02401 | NA | Eubacterium siraeum |
| 2456799 | COG4786 | K02392 | NA | Eubacterium siraeum |
| 2456801 | COG1871 | K03411 | map02030 | Eubacterium siraeum |
| 2457057 | COG0020 | K00806 | map00900 | Eubacterium siraeum |
| 2457060 | COG0821 | K03526 | map00100 | Eubacterium siraeum |
| 2457206 | NA | NA | NA | Eubacterium siraeum |
| 2457256 | COG0621 | K08070 | NA | Eubacterium siraeum |
| 2457257 | NA | NA | NA | Eubacterium siraeum |
| 2457261 | NA | NA | NA | Eubacterium siraeum |
| 2457595 | NOG21970 | NA | NA | Eubacterium siraeum |
| 2458384 | NA | NA | NA | Eubacterium siraeum |
| 2458514 | COG0712 | K02113 | map00190 | Eubacterium siraeum |
| 2458540 | COG0642 | K00936 | NA | Eubacterium siraeum |
| 2458604 | COG1136 | K02003 | NA | Eubacterium siraeum |
| 2458618 | COG0240 | K00057 | map00564 | Eubacterium siraeum |
| 2459196 | NA | NA | NA | Eubacterium siraeum |
| 2459198 | COG1397 | K01250 | NA | Eubacterium siraeum |
| 2459664 | NOG09637 | K01043 | NA | Eubacterium siraeum |
| 2460215 | COG0082 | K01736 | map00400 | Eubacterium siraeum |
| 2460216 | NA | NA | NA | Eubacterium siraeum |
| 2460219 | COG0124 | K01892 | map00340 | Eubacterium siraeum |
| 2460220 | COG2894 | K03609 | NA | Eubacterium siraeum |
| 2460225 | COG0826 | K08303 | map05120 | Eubacterium siraeum |
| 2460226 | NA | NA | NA | Eubacterium siraeum |
| 2460234 | COG0438 | K00754 | map00051 | Eubacterium siraeum |
| 2461916 | COG4509 | K08600 | NA | Eubacterium siraeum |
| 2461922 | COG3629 | NA | NA | Eubacterium siraeum |
| 2462163 | COG0582 | NA | NA | Roseburia inulinivorans |
| 2462512 | COG0365 | K01895 | map00010 | cellular organisms |
| 2462870 | COG0518 | K01951 | map00230 | Bacteria |
| 2462872 | NA | NA | NA | Eubacterium siraeum |
| 2462924 | COG1200 | K03655 | map03440 | Clostridiales |
| 2462929 | COG1522 | K03719 | NA | Eubacterium siraeum |
| 2463053 | COG0289 | K00215 | map00300 | Eubacterium siraeum |
| 2463057 | COG0343 | K00773 | NA | Eubacterium siraeum |
| 2463068 | COG1162 | K06949 | NA | Eubacterium siraeum |
| 2463229 | COG0002 | K00145 | map00220 | Eubacterium siraeum |
| 2463231 | COG0548 | K00930 | map00220 | Eubacterium siraeum |
| 2463234 | COG0053 | K03295 | NA | Eubacterium siraeum |
| 2463243 | NA | NA | NA | Ruminococcus lactaris |
| 2463387 | COG1219 | K03544 | NA | Eubacterium siraeum |
| 2463393 | COG0164 | K03470 | map03030 | Eubacterium siraeum |
| 2463486 | NA | NA | NA | Eubacterium siraeum |
| 2463493 | COG1394 | K02120 | map00190 | Eubacterium siraeum |
| 2463494 | NA | NA | NA | Eubacterium siraeum |
| 2463545 | COG0507 | K03581 | map03440 | Clostridiales |
| 2463561 | NA | NA | NA | Eubacterium siraeum |
| 2463563 | NA | NA | NA | Eubacterium siraeum |
| 2463872 | COG1482 | K01809 | map00051 | Eubacterium siraeum |
| 2464286 | NA | NA | NA | Eubacterium siraeum |
| 2464289 | NA | K00378 | NA | Eubacterium siraeum |
| 2464668 | COG1083 | K00983 | map00530 | Clostridium |
| 2464742 | COG0148 | K01689 | map00010 | Clostridiales |
| 2464744 | COG1696 | K00680 | map00350 | Eubacterium siraeum |
| 2464865 | COG0488 | K06020 | NA | Bacteria |
| 2465062 | COG1132 | K06147 | NA | Clostridiales |
| 2465063 | NA | NA | NA | Eubacterium siraeum |
| 2465248 | NA | NA | NA | Eubacterium siraeum |
| 2465384 | COG0438 | K00754 | map00051 | Eubacterium siraeum |
| 2465441 | COG1418 | K06950 | NA | Bacteria |
| 2465479 | NOG13976 | NA | NA | Eubacterium siraeum |
| 2465492 | COG1692 | K09769 | NA | Eubacterium siraeum |
| 2465497 | COG1963 | K09775 | NA | Eubacterium siraeum |
| 2465510 | NA | NA | NA | — |
| 2465515 | COG3411 | K00335 | map00130 | Eubacterium siraeum |
| 2465851 | COG0491 | K01069 | map00620 | Eubacterium siraeum |
| 2465861 | NA | NA | NA | Eubacterium siraeum |
| 2465862 | NA | NA | NA | Eubacterium siraeum |
| 2465867 | COG0733 | K03308 | NA | Clostridiales |
| 2465872 | COG0566 | K03437 | NA | Eubacterium siraeum |
| 2465873 | COG1206 | K04094 | NA | Eubacterium siraeum |
| 2465884 | COG0799 | K09710 | NA | Eubacterium siraeum |
| 2466012 | COG1132 | K06147 | NA | Eubacterium siraeum |
| 2466476 | COG2137 | K03565 | NA | Eubacterium siraeum |
| 2466481 | NA | NA | NA | Eubacterium siraeum |
| 2466512 | COG0234 | K04078 | NA | Eubacterium siraeum |
| 2466516 | COG1216 | K07011 | NA | Coprococcus eutactus |
| 2466519 | COG0463 | K00754 | map00051 | Eubacterium siraeum |
| 2466990 | COG1027 | K01744 | map00252 | Clostridium bartlettii |
| 2467037 | NA | NA | NA | — |
| 2467038 | NA | NA | NA | — |
| 2467046 | NA | NA | NA | — |
| 2467057 | COG0041 | K01588 | map00230 | Eubacterium siraeum |
| 2467752 | COG0698 | K01808 | map00030 | Eubacterium siraeum |
| 2467939 | COG1493 | K06023 | NA | Eubacterium siraeum |
| 2467945 | COG3935 | NA | NA | Eubacterium siraeum |
| 2467946 | COG1484 | K02315 | NA | Eubacterium siraeum |
| 2467989 | COG0245 | K00991 | map00100 | Eubacterium siraeum |
| 2468080 | NA | NA | NA | Eubacterium siraeum |
| 2468310 | COG0652 | K01802 | NA | Eubacterium siraeum |
| 2468311 | COG0652 | K01802 | NA | Eubacterium siraeum |
| 2468584 | COG2000 | K00533 | map00630 | Eubacterium siraeum |
| 2468682 | COG0428 | K07238 | NA | Eubacterium siraeum |
| 2468743 | COG4481 | NA | NA | Eubacterium siraeum |
| 2468838 | COG4100 | K01758 | map00260 | Eubacterium siraeum |
| 2468881 | COG0440 | K01653 | map00290 | Eubacterium siraeum |
| 2468882 | COG0028 | K01652 | map00290 | Clostridiales |
| 2469208 | COG0311 | K08681 | map00750 | Eubacterium siraeum |
| 2469269 | COG0704 | K02039 | NA | Eubacterium siraeum |
| 2469961 | COG0024 | K01265 | NA | Eubacterium siraeum |
| 2470527 | COG3201 | K03811 | NA | Eubacterium siraeum |
| 2470554 | COG1609 | K05499 | NA | Eubacterium siraeum |
| 2470563 | COG0494 | K01554 | NA | Eubacterium siraeum |
| 2470657 | COG1284 | NA | NA | Eubacterium siraeum |
| 2470658 | COG1939 | K11145 | NA | Eubacterium siraeum |
| 2470796 | COG0540 | K00609 | map00240 | Eubacterium siraeum |
| 2471706 | NA | K07052 | NA | Eubacterium siraeum |
| 2471750 | COG3250 | NA | NA | Clostridiales |
| 2471751 | NA | NA | NA | Eubacterium siraeum |
| 2471898 | COG2017 | K01785 | map00010 | Eubacterium siraeum |
| 2471899 | COG0474 | K01529 | map00790 | Bacteria |
| 2471924 | COG0389 | K02346 | NA | Eubacterium siraeum |
| 2472094 | COG0696 | K01834 | map00010 | Bacteria |
| 2472146 | NOG21937 | K00548 | map00271 | Eubacterium siraeum |
| 2472541 | NOG06161 | K06394 | NA | Eubacterium siraeum |
| 2472571 | COG1686 | K01286 | NA | Eubacterium siraeum |
| 2472574 | COG1386 | K06024 | NA | Eubacterium siraeum |
| 2472576 | COG0577 | K02004 | NA | Clostridium |
| 2472579 | COG1595 | K03088 | NA | Eubacterium siraeum |
| 2472598 | NA | NA | NA | Eubacterium siraeum |
| 2472697 | COG4905 | K06950 | NA | Eubacterium siraeum |
| 2472807 | COG1748 | K00290 | map00300 | Bacteria |
| 2472809 | COG5001 | NA | NA | Eubacterium siraeum |
| 2472906 | COG0546 | K01091 | map00630 | Eubacterium siraeum |
| 2472958 | COG1420 | K03705 | NA | Eubacterium siraeum |
| 2473100 | COG0265 | K01362 | NA | Eubacterium siraeum |
| 2473121 | COG3635 | K01834 | map00010 | Eubacterium siraeum |
| 2473157 | COG0220 | K03439 | NA | Eubacterium siraeum |
| 2473220 | NA | NA | NA | Eubacterium siraeum |
| 2473306 | COG1696 | K00680 | map00350 | Eubacterium siraeum |
| 2473365 | NA | NA | NA | Eubacterium siraeum |
| 2473510 | COG0769 | K01928 | map00300 | Eubacterium siraeum |
| 2473530 | COG3459 | K00754 | map00051 | Clostridiales |
| 2473746 | NA | NA | NA | Eubacterium siraeum |
| 2473748 | NA | NA | NA | Eubacterium siraeum |
| 2473756 | COG1132 | K06147 | NA | Eubacterium siraeum |
| 2473811 | COG3507 | K01198 | map00500 | Eubacterium siraeum |
| 2474002 | COG0122 | K03660 | NA | Eubacterium siraeum |
| 2474079 | COG1388 | NA | NA | Eubacterium siraeum |
| 2474081 | NOG09621 | NA | NA | Eubacterium siraeum |
| 2474086 | COG1328 | K00527 | map00230 | Bacteria |
| 2474090 | COG0813 | K03784 | map00230 | Eubacterium siraeum |
| 2474115 | COG0395 | K02026 | NA | Eubacterium siraeum |
| 2474124 | COG0793 | K03797 | NA | Eubacterium siraeum |
| 2474127 | COG2884 | K09812 | NA | Eubacterium siraeum |
| 2474221 | COG0600 | K02050 | NA | Eubacterium siraeum |
| 2474310 | COG3481 | NA | NA | Eubacterium siraeum |
| 2474316 | NOG08575 | K06012 | NA | Eubacterium siraeum |
| 2474365 | NA | NA | NA | Eubacterium siraeum |
| 2474371 | COG0726 | K01463 | NA | Eubacterium siraeum |
| 2474498 | NA | NA | NA | Eubacterium siraeum |
| 2474511 | NA | NA | NA | — |
| 2474613 | COG0038 | K03281 | NA | Eubacterium siraeum |
| 2474656 | NA | NA | NA | Eubacterium siraeum |
| 2474665 | NA | NA | NA | Eubacterium siraeum |
| 2474748 | COG0116 | K07444 | NA | Eubacterium siraeum |
| 2474837 | COG4894 | NA | NA | Eubacterium siraeum |
| 2474907 | NA | NA | NA | Eubacterium siraeum |
| 2474915 | COG1195 | K03629 | NA | Eubacterium siraeum |
| 2474917 | COG1451 | K07043 | NA | Eubacterium siraeum |
| 2474919 | NOG08375 | K01218 | map00051 | Eubacterium siraeum |
| 2474986 | COG1159 | K03595 | NA | Eubacterium siraeum |
| 2474991 | COG3314 | K02053 | NA | Eubacterium siraeum |
| 2475014 | NA | NA | NA | Eubacterium siraeum |
| 2477731 | NA | NA | NA | Eubacterium siraeum |
| 2477739 | COG0328 | K03469 | map03030 | Eubacterium siraeum |
| 2477876 | COG0494 | K01518 | map00230 | Eubacterium siraeum |
| 2477983 | NA | NA | NA | Clostridium leptum |
| 2478115 | COG1210 | K00963 | map00040 | Eubacterium siraeum |
| 2478163 | COG1737 | NA | NA | Eubacterium siraeum |
| 2478169 | COG0313 | K07056 | NA | Eubacterium siraeum |
| 2479705 | COG0103 | K02996 | NA | Bifidobacterium |
| 2501910 | COG1434 | K03748 | NA | Listeria |
| 2525616 | COG0150 | K01933 | map00230 | Eubacterium ventriosum |
| 2529256 | NA | NA | NA | Clostridium thermocellum |
| 2529598 | NA | NA | NA | — |
| 2537409 | NA | NA | NA | — |
| 2539499 | COG4708 | NA | NA | Clostridia |
| 2541787 | COG1175 | K02025 | NA | Faecalibacterium prausnitzii |
| 2544447 | NA | NA | NA | — |
| 2564507 | NA | K02014 | NA | Bacteroides |
| 2568292 | NA | K03321 | NA | Bacteroides |
| 2582519 | NA | NA | NA | Bacteroides pectinophilus |
| 2594366 | NOG14428 | NA | NA | — |
| 2628214 | COG3587 | K01156 | NA | Bacteroides capillosus |
| 2632187 | NA | NA | NA | — |
| 2633339 | COG1670 | K03790 | NA | Eubacterium biforme |
| 2634585 | COG0653 | K03070 | NA | Bacteroides capillosus |
| 2634594 | COG0182 | K08963 | map00271 | Clostridium tetani |
| 2634673 | COG0538 | K00031 | map00020 | — |
| 2635407 | COG1968 | K06153 | map00550 | Bacteroides capillosus |
| 2636230 | COG1109 | K01835 | map00010 | Bacteroides capillosus |
| 2637449 | COG1883 | K01572 | map00330 | Alistipes putredinis |
| 2639825 | COG1328 | K00527 | map00230 | Anaerostipes caccae |
| 2641942 | COG0745 | K07657 | NA | Clostridium |
| 2644831 | NA | NA | NA | — |
| 2645558 | COG1847 | K06346 | NA | Bacteroides capillosus |
| 2651546 | KOG4494 | K01511 | map00230 | Cryptosporidium |
| 2651799 | COG0542 | K03696 | NA | Bacteria |
| 2671057 | COG2848 | K09157 | NA | — |
| 2694475 | NA | NA | NA | Faecalibacterium prausnitzii |
| 2711042 | NA | NA | NA | Faecalibacterium prausnitzii |
| 2715919 | COG3973 | K01529 | map00790 | Atopobium rimae |
| 2716426 | COG2814 | K08156 | NA | Alistipes putredinis |
| 2748603 | COG5658 | NA | NA | Bacteroides pectinophilus |
| 2782815 | NOG07866 | K06438 | NA | Clostridium thermocellum |
| 2783253 | NA | NA | NA | Ruminococcus torques |
| 2792520 | NA | NA | NA | — |
| 2814936 | NA | NA | NA | Eubacterium siraeum |
| 2817698 | COG0768 | K08384 | NA | Anoxybacillus flavithermus |
| 2818142 | COG0272 | K01972 | map03030 | Clostridium bolteae |
| 2819291 | COG0635 | K02495 | map00860 | Clostridium cellulolyticum |
| 2820917 | COG0448 | K00975 | map00500 | Clostridiales |
| 2827561 | COG0475 | K03455 | NA | Firmicutes |
| 2827837 | COG1686 | K07258 | NA | Clostridium hylemonae |
| 2829342 | COG3191 | K01266 | NA | Brachyspira |
| 2829949 | NA | NA | NA | — |
| 2830322 | NA | K02335 | map00230 | Clostridium |
| 2835894 | COG0635 | K02495 | map00860 | Clostridium nexile |
| 2837148 | NOG21724 | NA | NA | Bacteria |
| 2838517 | COG1438 | K03402 | NA | Clostridium |
| 2838518 | COG0497 | K03631 | NA | Clostridium thermocellum |
| 2838861 | COG2183 | K06959 | NA | Bacteria |
| 2841034 | NOG22767 | K02014 | NA | Bacteroides |
| 2847376 | COG2207 | K02854 | NA | Opitutaceae |
| 2849498 | NA | NA | NA | — |
| 2849500 | NA | NA | NA | — |
| 2849709 | COG1288 | NA | NA | Clostridium |
| 2851283 | NA | NA | NA | — |
| 2855097 | COG0840 | K03406 | NA | Roseburia inulinivorans |
| 2859982 | NA | NA | NA | Eubacterium hallii |
| 2860802 | COG0183 | K00632 | map00071 | Heliobacterium modesticaldum |
| 2862330 | NA | NA | NA | Bacteria |
| 2869555 | NA | NA | NA | — |
| 2872829 | COG0569 | K03499 | NA | Eubacterium siraeum |
| 2873094 | COG0343 | K00773 | NA | Clostridium |
| 2875346 | COG0002 | K00145 | map00220 | Bacteroides capillosus |
| 2876416 | NA | NA | NA | — |
| 2884263 | NA | NA | NA | Clostridium scindens |
| 2884377 | NA | NA | NA | Ruminococcus lactaris |
| 2887016 | COG4656 | K03615 | NA | Clostridium botulinum |
| 2888058 | COG1208 | K00966 | map00051 | Clostridia |
| 2891219 | NA | NA | NA | — |
| 2891767 | COG3345 | K07407 | map00052 | Eubacterium siraeum |
| 2897923 | NA | NA | NA | Bacteria |
| 2898468 | NA | NA | NA | Eubacterium siraeum |
| 2898470 | COG2510 | K08978 | NA | Firmicutes |
| 2900944 | NA | NA | NA | — |
| 2903523 | COG0591 | K03307 | NA | — |
| 2907159 | NA | NA | NA | — |
| 2907797 | COG1961 | K06400 | NA | Bacteroides capillosus |
| 2910582 | COG1284 | NA | NA | Clostridium |
| 2914751 | COG3326 | K01175 | NA | Firmicutes |
| 2916000 | COG0060 | K01870 | map00290 | Anaerostipes caccae |
| 2919636 | COG0389 | K02346 | NA | Roseburia inulinivorans |
| 2921137 | COG0558 | K00995 | map00564 | Clostridium phytofermentans |
| 2922371 | NA | NA | NA | Clostridiales |
| 2924258 | NA | NA | NA | — |
| 2925517 | NA | K04096 | NA | Proteobacteria |
| 2926480 | NA | NA | NA | — |
| 2929649 | NA | NA | NA | — |
| 2929744 | COG0436 | K00821 | map00300 | Firmicutes |
| 2930117 | COG1092 | K06969 | NA | — |
| 2931216 | COG1387 | K04477 | NA | Dethiobacter alkaliphilus |
| 2934515 | NA | NA | NA | — |
| 2936469 | KOG2137 | K08819 | NA | Eukaryota |
| 2938639 | COG2723 | K05350 | map00460 | Halothermothrix orenii |
| 2941644 | COG1349 | K03436 | NA | Anaerocellum thermophilum |
| 2943789 | COG1472 | K05349 | map00460 | Clostridium butyricum |
| 2947471 | COG1459 | K02653 | NA | Clostridiales |
| 2947472 | COG1989 | K02654 | NA | Geobacter bemidjiensis |
| 2948722 | COG0024 | K01265 | NA | Clostridium |
| 2950758 | COG0250 | K02601 | NA | Clostridia |
| 2951031 | NA | NA | NA | — |
| 2951248 | NA | K00936 | NA | Coprococcus eutactus |
| 2954320 | NA | NA | NA | — |
| 2955125 | COG3103 | K01447 | map00550 | Roseburia inulinivorans |
| 2958543 | COG0469 | K00873 | map00010 | Bacteria |
| 2961294 | COG0338 | K06223 | map03430 | Anaerofustis stercorihominis |
| 2962201 | NA | NA | NA | Clostridium leptum |
| 2962272 | COG0395 | K02026 | NA | Xanthomonas |
| 2963844 | COG1198 | K04066 | map03440 | Thermoanaerobacter pseudethanolicus |
| 2964411 | NA | NA | NA | Mollicutes |
| 2965526 | NA | NA | NA | — |
| 2965664 | COG2720 | NA | NA | Moorella thermoacetica |
| 2965666 | NA | NA | NA | Clostridium phytofermentans |
| 2966637 | COG1354 | K05896 | NA | Bacteria |
| 2969494 | NA | K00527 | map00230 | Clostridiales |
| 2969688 | NA | NA | NA | Eubacterium ventriosum |
| 2971689 | COG1175 | K02025 | NA | Bacillus |
| 2972825 | COG0458 | K01955 | map00240 | cellular organisms |
| 2973080 | COG3857 | K01144 | NA | Clostridiaceae |
| 2973764 | COG0665 | K00100 | map00051 | Bacteria |
| 2975705 | COG1104 | K04487 | map00730 | Roseburia inulinivorans |
| 2975971 | NOG10993 | NA | NA | Anaerostipes caccae |
| 2976529 | COG4209 | K02025 | NA | Clostridium phytofermentans |
| 2979740 | COG0714 | K03924 | NA | Bacteria |
| 2980214 | NA | NA | NA | Clostridium |
| 2981160 | COG0786 | K03312 | NA | Bacteria |
| 2987047 | COG1882 | K00656 | map00620 | Clostridium |
| 2992081 | COG3314 | K02053 | NA | Alkaliphilus metalliredigens |
| 2993707 | COG0524 | K00852 | map00030 | Clostridium phytofermentans |
| 2997147 | COG1925 | K11184 | NA | Bacteria |
| 2998918 | COG1585 | NA | NA | Ruminococcus lactaris |
| 2999952 | NA | NA | NA | Actinobacteria (class) |
| 3003769 | COG1132 | K06147 | NA | Clostridiales |
| 3005166 | NA | NA | NA | Clostridium scindens |
| 3006342 | COG0149 | K01803 | map00010 | Clostridiales |
| 3008301 | COG1896 | K07023 | NA | Desulfitobacterium hafniense |
| 3008857 | COG0228 | K02959 | NA | Clostridia |
| 3009757 | COG1979 | K00100 | map00051 | Clostridium botulinum |
| 3010870 | NA | NA | NA | — |
| 3010935 | NA | NA | NA | Ruminococcus obeum |
| 3014465 | COG0534 | K03327 | NA | Clostridiales |
| 3015468 | COG0206 | K03531 | NA | Clostridiaceae |
| 3015673 | COG1961 | K06400 | NA | Heliobacterium modesticaldum |
| 3016755 | COG1217 | K06207 | NA | Clostridium methylpentosum |
| 3016769 | COG1175 | K02025 | NA | Firmicutes |
| 3019202 | NA | NA | NA | — |
| 3026023 | NA | NA | NA | — |
| 3026580 | COG0135 | K01817 | map00400 | Parabacteroides distasonis |
| 3028668 | COG0474 | K01552 | NA | Firmicutes |
| 3032089 | COG0217 | K00975 | map00500 | Clostridium thermocellum |
| 3032160 | COG0020 | K00806 | map00900 | Anaerostipes caccae |
| 3034076 | NA | NA | NA | Bacteroides capillosus |
| 3035293 | NOG16635 | NA | NA | Clostridium thermocellum |
| 3039344 | COG0366 | K01182 | map00052 | — |
| 3041109 | NA | NA | NA | Bacteroides capillosus |
| 3041567 | NA | NA | NA | — |
| 3041574 | NA | NA | NA | — |
| 3041736 | NA | NA | NA | Clostridium asparagiforme |
| 3042513 | COG1190 | K04567 | map00300 | Bacteroides capillosus |
| 3043564 | NA | NA | NA | — |
| 3048082 | NA | NA | NA | — |
| 3049520 | NA | NA | NA | — |
| 3055761 | COG1132 | K06147 | NA | Clostridiales |
| 3056613 | NA | NA | NA | Eubacterium hallii |
| 3060056 | NA | NA | NA | — |
| 3062402 | COG4769 | K00805 | map00100 | Coprococcus comes |
| 3063523 | COG2304 | K07114 | NA | Bacteria |
| 3073787 | COG1932 | K00831 | map00260 | Firmicutes |
| 3076195 | NA | NA | NA | Salmonella enterica |
| 3076698 | COG0546 | K01091 | map00190 | Firmicutes |
| 3077518 | COG1234 | K00784 | NA | Trichoplax |
| 3083605 | COG1074 | K01144 | map03440 | Bacteria |
| 3085232 | COG1564 | K00949 | map00730 | Clostridium phytofermentans |
| 3086484 | NA | NA | NA | Acholeplasma laidlawii |
| 3088158 | COG1521 | K03525 | map00770 | Firmicutes |
| 3089940 | NA | NA | NA | Clostridium |
| 3090704 | COG2155 | K09779 | NA | Clostridia |
| 3092252 | NA | NA | NA | — |
| 3095823 | COG1876 | K01286 | NA | Bacilli |
| 3101933 | COG0779 | K09748 | NA | — |
| 3103035 | COG0332 | K00648 | map00061 | — |
| 3106158 | COG2715 | K06373 | NA | Bacteria |
| 3106324 | NA | NA | NA | — |
| 3109891 | COG1760 | K01752 | map00260 | Clostridium |
| 3110058 | NA | K03272 | map00540 | Methylocella silvestris |
| 3113095 | COG0647 | K01101 | map00361 | cellular organisms |
| 3113468 | NA | NA | NA | — |
| 3114498 | COG1200 | K03655 | map03440 | Eubacterium dolichum |
| 3116845 | COG0601 | K02033 | NA | Firmicutes |
| 3119535 | COG1105 | K00882 | map00051 | Roseburia inulinivorans |
| 3121268 | COG2755 | K01045 | map00363 | Roseburia inulinivorans |
| 3122770 | COG0044 | K01465 | map00240 | Bacteria |
| 3125100 | COG0370 | K04759 | NA | Clostridium |
| 3125541 | NA | NA | NA | — |
| 3128094 | COG0793 | K03797 | NA | Faecalibacterium prausnitzii |
| 3129139 | COG0526 | K03671 | NA | Bacteria |
| 3131537 | COG1739 | K00560 | map00240 | Clostridium |
| 3134065 | NA | NA | NA | Eubacterium siraeum |
| 3142255 | COG1887 | K01005 | map00440 | Erysipelotrichaceae |
| 3143623 | COG4720 | NA | NA | Alkaliphilus oremlandii |
| 3144515 | NA | K06926 | NA | Firmicutes |
| 3145625 | NA | NA | NA | — |
| 3146945 | NA | NA | NA | — |
| 3147213 | COG1135 | K02071 | NA | Clostridiales |
| 3154733 | COG1349 | K03436 | NA | Bacillus |
| 3173038 | COG4175 | K02000 | map02010 | Clostridium hylemonae |
| 3175284 | NA | NA | NA | — |
| 3175391 | COG1024 | K01692 | map00071 | Clostridium beijerinckii |
| 3181255 | NA | NA | NA | — |
| 3192174 | NA | NA | NA | Desulfitobacterium hafniense |

1.-8. (canceled)

9. A method for diagnosing obesity, said method comprising determining whether at least one gene from Table 1 is absent from an individual's gut microbiome.

10. The method of claim 1, wherein at least 50% of the genes of Table 1 are absent from the said individual's gut microbiome.

11. The method of claim 1 wherein at least 75% of the genes of Table 1 are absent from the said individual's gut microbiome.

12. The method of claim 1 wherein at least 90% of the genes of Table 1 are absent from the said individual's gut microbiome.

13. The method of claim 1 wherein the at least one gene from Table 1 is a gene from Firmicutes.

14. The method of claim 1 comprising obtaining microbial DNA from faeces of the said individual.

15. A method for monitoring the efficacy of a treatment for obesity in a patient in need thereof comprising first determining whether at least one gene is absent from the said patient's microbiome, administering the treatment, and determining if the said at least one gene is present in the patient's microbiome after the treatment.

16. The method of claim 15 wherein at least 50% of the genes of Table 1 are absent from the said individual's gut microbiome before the treatment.

17. The method of claim 15 wherein at least 75% of the genes of Table 1 are absent from the said individual's gut microbiome before the treatment.

18. The method of claim 15 wherein at least 90% of the genes of Table 1 are absent from the said individual's gut microbiome before the treatment.

19. The method of claim 15 comprising at least one step of obtaining microbial DNA from faeces of the said individual.

20. A microarray comprising probes hybridizing to at least 10% of the genes of Table 1.

21. The microarray of claim 20 comprising probes hybridizing to at least 50% of the genes of Table 1.

22. The microarray of claim 20 comprising probes hybridizing to at least 95%, of the genes of Table 1.

23. The microarray of claim 20 comprising probes hybridizing to at least 97.5%, of the genes of Table 1.

24. The microarray of claim 20 comprising probes hybridizing to at least 99% of the genes of Table 1.

25. A kit for diagnosing obesity comprising a microarray of claim 20 or amplification primers specific for at least 10% of the genes of Table 1.

26. A kit for diagnosing obesity comprising a microarray of claim 21 or amplification primers specific for at least 50% of the genes of Table 1.

27. A kit for diagnosing obesity comprising a microarray of claim 22 or amplification primers specific for at least 95% of the genes of Table 1.

28. A kit for diagnosing obesity comprising a microarray of claim 24 or amplification primers specific for at least 99% of the genes of Table 1.
